(19) United States
(12) Patent Application Publication
(10) Pub. No.: US 2025/0143214 A1
(43) Pub. Date: May 8, 2025

(54) CONTROL SYSTEM, CONTROL METHOD, AND DELIVERY VEHICLE

(71) Applicant: Kubota Corporation, Osaka (JP)

(72) Inventor: Jumpei MIKI, Sakai-shi (JP)

(21) Appl. No.: 19/001,705

(22) Filed: Dec. 26, 2024

Related U.S. Application Data
(63) Continuation of application No. PCT/JP2023/023410, filed on Jun. 23, 2023.

(30) Foreign Application Priority Data
Jun. 28, 2022 (JP) 2022-103747

(51) Int. Cl. A01D 43/073; A01B 69/04

(52) U.S. Cl. CPC A01D 43/073; A01B 69/008

(57) ABSTRACT

A control system includes a first controller configured or programmed to control an operation of discharging a harvested crop of an agricultural machine, and a second controller configured or programmed to control an operation of the transport vehicle so that the transport vehicle travels by automated driving and to perform a control to increase a distance between the agricultural machine and the transport vehicle while the agricultural machine makes a turn, compared to when the agricultural machine is traveling while harvesting the crop.

### CROSS REFERENCE TO RELATED APPLICATIONS

This application claims the benefit of priority to Japanese Patent Application No. 2022-103747 filed on Jun. 28, 2022 and is a Continuation Application of PCT Application No. PCT/JP2023/023410 filed on Jun. 23, 2023. The entire contents of each application are hereby incorporated herein by reference.

### BACKGROUND OF THE INVENTION

### 1. Field of the Invention

The present disclosure relates to control systems, control methods, and transport vehicles used for harvesting a crops.

### 2. Description of the Related Art

Research and development of smart agriculture, which utilizes ICT (Information and Communication Technology) and IoT (Internet of Things), are being carried out as next-generation agriculture. Research and development are also being carried out with the aim of realizing automated driving and unmanned driving of agricultural machines such as tractors and harvesters used in fields. For example, agricultural machines that perform agricultural work while traveling in fields by automated driving using a positioning system such as GNSS (Global Navigation Satellite System) that can perform precise positioning are being put into practical use.

JP 2018-073399 A discloses a harvester that travels by automated driving while harvesting the crop in the field. The harvester can harvest the crop by traveling along a pre-set travel route in the field.

### SUMMARY OF THE INVENTION

There is a need to harvest crops in fields more efficiently.

A control system according to an example embodiment of the present disclosure is a control system for controlling a harvesting operation performed by an agricultural machine, which harvests a crop while traveling in a field by automated driving, and a transport vehicle, which receives a harvested crop discharged from the agricultural machine while traveling alongside the agricultural machine by automated driving, the control system including a first controller configured or programmed to perform an operation of discharging the harvested crop of the agricultural machine, and a second controller configured or programmed to perform an operation of the transport vehicle so that the transport vehicle travels by automated driving, wherein the second controller is configured or programmed to perform a control to increase a distance between the agricultural machine and the transport vehicle while the agricultural machine makes a turn, compared to when the agricultural machine is traveling while harvesting the crop.

A transport vehicle according to an example embodiment of the present disclosure is a transport vehicle for transporting a harvested crop that is harvested in a field, the transport vehicle including a container to receive and store the harvested crop discharged from an agricultural machine that harvests the crop in the field, and a controller configured or programmed to perform an operation of the transport vehicle so that the transport vehicle travels by automated driving, wherein the controller is configured or programmed to perform a control to cause the transport vehicle to travel alongside the agricultural machine when the agricultural machine is traveling while harvesting the crop and discharging the harvested crop, and perform a control to increase a distance between the agricultural machine and the transport vehicle when the agricultural machine is making a turn, compared to when the agricultural machine is traveling while harvesting the crop.

A control method according to an example embodiment of the present disclosure is a control method for controlling a harvesting operation performed by an agricultural machine, which harvests a crop while traveling in a field by automated driving, and a transport vehicle, which receives a harvested crop discharged from the agricultural machine while traveling alongside the agricultural machine by automated driving, the control method including controlling an operation of discharging the harvested crop of the agricultural machine, and performing a control to increase a distance between the agricultural machine and the transport vehicle while the agricultural machine makes a turn, compared to when the agricultural machine is traveling while harvesting the crop.

A control method according to an example embodiment of the present disclosure is a control method for controlling a transport vehicle that travels by automated driving and transports a harvested crop that is harvested in a field, wherein the transport vehicle includes a container to receive and store the harvested crop discharged from an agricultural machine that harvests the crop in the field, the control method including performing a control to cause the transport vehicle to travel alongside the agricultural machine when the agricultural machine is traveling while harvesting the crop and discharging the harvested crop, and performing a control to increase a distance between the agricultural machine and the transport vehicle when the agricultural machine is making a turn, compared to when the agricultural machine is traveling while harvesting the crop.

Example embodiments of the present disclosure may be realized by apparatuses, systems, methods, integrated circuits, computer programs, or non-transitory computer readable non-transitory storage media, or any combination thereof. The non-transitory computer readable storage media may include a volatile storage medium or a nonvolatile storage medium. Each of the apparatuses may include a plurality of apparatuses. Where one of the apparatuses includes two or more apparatuses, the two or more apparatuses may be included within a single device or may be provided separately within two or more separate devices.

According to example embodiments of the present disclosure, agricultural machines and transport vehicles travel alongside each other while maintaining a positional relationship in which the transport vehicles can receive the harvested crop discharged from the agricultural machines. Crops in fields can be harvested efficiently by having the agricultural machines, which harvest the crop, and the transport vehicles, which receive and store the harvested crops discharged from the agricultural machines, travel alongside each other. On the other hand, controlling the agricultural machines and the transport vehicles to turn while maintaining the positional relationship described above is complicated.

By increasing the distances between the agricultural machines and the transport vehicles while the agricultural machines are making a turn, it is possible to prevent the presence of the transport vehicles from interfering with the smooth turning of the agricultural machines. For example, even when making a complicated turn involving backing up, the agricultural machines can perform the turn smoothly.

By increasing the distance between the agricultural machines and the transport vehicles while the agricultural machine is making a turn, it is possible to prevent the presence of the agricultural machines from interfering with the smooth turning of the transport vehicles.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a diagram illustrating an overview of an agricultural management system according to an example embodiment of the present disclosure.

FIG. 2 is a side view schematically showing an example of a harvester.

FIG. 3 is a side view schematically showing an example of a transport vehicle.

FIG. is a block diagram showing an example configuration of the harvester.

FIG. 5 is a block diagram showing an example configuration of the transport vehicle.

FIG. 6 is a block diagram showing an example configuration of a management device and a terminal device.

FIG. 7 is a diagram showing a harvesting operation of harvesting a crop in the field using the harvester and the transport vehicle.

FIG. 8 is a flow chart showing an example control for the harvesting operation of harvesting the crop in the field using the harvester and the transport vehicle.

FIG. 9 is a diagram showing an example of the harvester that travels automatically along a target route in the field and the transport vehicle that travels alongside the harvester.

FIG. 10 is a diagram showing the harvester and the transport vehicle having moved forward while traveling alongside each other.

FIG. 11 is a diagram showing how the transport vehicle, having traveled alongside the harvester, moves away from the harvester.

FIG. 12 is a diagram showing the harvester turning along a turning route.

FIG. 13 is a diagram showing the harvester having turned and traveling along the next main route.

FIG. 14 is a diagram showing the transport vehicle having reached a position for traveling alongside the harvester.

FIG. 15 is a diagram showing an example of a turning route.

FIG. 16 is a diagram showing how the transport vehicle, which has traveled alongside the harvester, moves away from the harvester.

FIG. 17 is a diagram showing the harvester turning along the turning route.

FIG. 18 is a diagram showing the harvester turning along the turning route.

FIG. 19 is a diagram showing the transport vehicle waiting at a predetermined position in a field.

FIG. 20 is a diagram showing the transport vehicle moving toward a position where the transport vehicle can receive the harvested crop discharged from the harvester.

FIG. 21 is a diagram showing the transport vehicle having reached a position where the transport vehicle can receive the harvested crop discharged from the harvester.

FIG. 22 is a diagram showing the transport vehicle moving to a storage shed to store the harvested crop.

### DETAILED DESCRIPTION OF THE EXAMPLE EMBODIMENTS

In the present disclosure, an “agricultural machine” refers to a for machine agricultural applications. The agricultural machine of the present disclosure is a mobile agricultural machine capable of performing agricultural work while moving. Examples of agricultural machines include tractors, harvesters, rice transplanters, vehicles for crop management, vegetable transplanters, mowers, seeders, spreaders, and mobile robots for agriculture. Not only may an agricultural machine such as a tractor function as an “agricultural machine” alone by itself, but also a combination of an agricultural machine and an implement that is attached to, or towed by, the agricultural machine may function as an “agricultural machine”. For the ground surface inside a field, the agricultural machine performs agricultural work such as tilling, seeding, preventive pest control, manure spreading, planting of crops, or harvesting. Such agricultural work or tasks may be referred to as “groundwork”, or simply as “work” or “tasks”. Travel of a vehicle-type agricultural machine performed while the agricultural machine also performs agricultural work may be referred to as “tasked travel”.

“Automated driving” refers to controlling the movement of an agricultural machine by the action of a controller, rather than through manual operations of a driver. An agricultural machine that performs automated driving may be referred to as an “automated driving agricultural machine” or a “robotic agricultural machine”. During automated driving, not only the movement of the agricultural machine, but also the operation of agricultural work (e.g., the operation of an implement) may be controlled automatically. In the case where the agricultural machine is a vehicle-type machine, travel of the agricultural machine via automated driving will be referred to as “self-traveling”. The controller may be configured or programmed to control at least one of steering that is required in the movement of the agricultural machine, adjustment of the moving speed, and beginning and ending of a move. In the case of controlling an agricultural machine having an implement attached thereto, the controller may be configured or programmed to control raising or lowering of the implement, beginning and ending of an operation of the implement, and so on. A move based on automated driving may include not only moving of an agricultural machine that goes along a predetermined path toward a destination, but also moving of an agricultural machine that follows a target of tracking. An agricultural machine that performs automated driving may also move partly based on the user's instructions. Moreover, an agricultural machine that performs automated driving may operate not only in an automated driving mode but also in a manual driving mode, where the agricultural machine moves through manual operations of the driver. When performed not manually but through the action of a controller, the steering of an agricultural machine will be referred to as “automatic steering”. A portion of, or the entirety of, the controller may reside outside the agricultural machine. Control signals, commands, data, etc., may be communicated between the agricultural machine and a controller existing outside the agricultural machine. An agricultural machine that performs automated driving may move autonomously while sensing the surrounding environment, without any person being involved in the controlling of the movement of the agricultural machine. An agricultural machine that is capable of autonomous movement is able to travel inside the field or outside the field (e.g., on roads) in an unmanned manner. During an autonomous move, operations of detecting and avoiding obstacles may be performed.

“Work plan” is data defining a plan of one or more tasks of agricultural work to be performed by an agricultural machine. The work plan may include, for example, information representing the order of the tasks of agricultural work to be performed by an agricultural machine and the field where each of the tasks of agricultural work is to be performed. The work plan may include information representing the day and time each of the tasks of agricultural work is to be performed. The work plan may be created by a processor communicating with the agricultural machine to manage the agricultural work, or by a processor mounted on the agricultural machine. The processor can create a work plan based on, for example, information input by the user (agricultural business executive, agricultural worker, etc.) manipulating a terminal device. In this specification, the processor communicating with the agricultural machine to manage the agricultural work will be referred to as a “management device”. The management device may manage agricultural work of a plurality of agricultural machines. In this case, the management device may create a work plan including information on each task of agricultural work to be performed by each of the plurality of agricultural machines. The work plan may be downloaded to each of the agricultural machines and stored in a storage device. In order to perform the scheduled agricultural work, each agricultural machine can automatically go to the field and perform the agricultural work according to the work plan.

An “environment map” is data that representing with a predetermined coordinate system, the position or the region of an object existing in the environment where the agricultural machine moves. The environment map may be referred to simply as a “map” or “map data”. The coordinate system defining the environment map may be a world coordinate system such as a geographic coordinate system fixed to the globe, for example. The environment map may include information other than the position (e.g., attribute information or other types of information) for objects that are present in the environment. The environment map encompasses various types of maps, such as a point cloud map or a grid map. Data on a local map or a partial map that is generated or processed in a process of constructing the environment map is also referred to as a “map” or “map data”.

“Farm road” means a road used mainly for agricultural purposes. A farm road is not limited to a road paved with asphalt, and encompasses unpaved roads covered with soil, gravel, etc. A farm road encompasses roads (including private roads) on which only vehicle-type agricultural machines (e.g., agricultural machines such as tractors) are allowed to travel and roads on which general vehicles (passenger cars, trucks, buses, etc.) are allowed to travel. The agricultural machines may automatically travel on a public road in addition to a farm road. The public road is a road maintained for traffic of general vehicles.

Hereinafter, example embodiments of the present disclosure will be described. Note, however, that unnecessarily detailed descriptions may be omitted. For example, detailed descriptions on what is well known in the art or redundant descriptions on what is substantially the same configuration may be omitted. This is to avoid lengthy description, and facilitate the understanding of those skilled in the art. Note that the accompanying drawings and the following description are not intended to limit the scope of the claims. In the following description, elements having identical or similar functions are denoted by identical reference numerals.

The following example embodiments are only exemplary, and the techniques according to the present disclosure are not limited to the following example embodiments. For example, numerical values, shapes, materials, steps, orders of steps, layout of a display screen, etc., which are indicated in the following example embodiments are only exemplary, and admit of various modifications so long as it makes technological sense. Any one implementation may be combined with another so long as it makes technological sense to do so.

Example embodiments in which the technology of the present disclosure are applicable to the harvester and the transport vehicle, which are examples of agricultural machines, will now be described. The technologies and example embodiments of the present disclosure can also be applied to other types of agricultural machines.

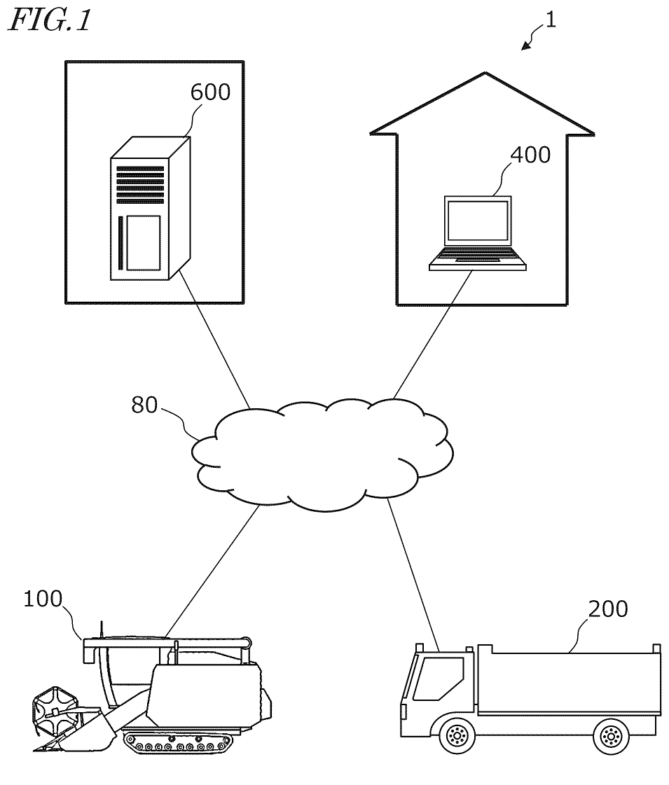

FIG. 1 is a diagram illustrating an overview of an agricultural management system 1 according to an example embodiment of the present disclosure. The agricultural management system 1 shown in FIG. 1 includes a harvester 100, a transport vehicle 200, a terminal device 400, and a management device 600.

The terminal device 400 is a computer used by a user who remotely monitors the harvester 100 and the transport vehicle 200. The management device 600 is a computer managed by an operator who operates the agricultural management system 1. The harvester 100, the transport vehicle 200, the terminal device 400, and the management device 600 can communicate with each other via a network 80. While FIG. 1 shows one harvester 100 and one transport vehicle 200, an agricultural management system 1 may include a plurality of harvesters 100 and/or a plurality of transport vehicles 200. The agricultural management may system 1 include other agricultural machines.

The harvester 100 of the present example embodiment may be a combine harvester, for example. The harvester machine 100 cuts the crop in the field, threshes the cut crop, and discharges the harvested crop after threshing. The crop in the field may be plants that can be harvested, such as rice, wheat, corn, soybeans, etc., but there is no limitation thereto.

The transport vehicle 200 of the present example embodiment is a vehicle provided with a container to receive and store the harvested crop discharged from the harvester 100, and may be a truck, for example.

The harvester 100 and the transport vehicle 200 has the automated driving function. That is, the harvester 100 and the transport vehicle 200 can travel without manual operation, but by the action of a controller. The controller of the present example embodiment is provided inside each of the harvester 100 and the transport vehicle 200, and can control both the speed and steering of the harvester 100 and the transport vehicle 200. The harvester 100 and the transport vehicle 200 may travel automatically not only in the field but also outside the field (e.g., on a road).

The harvester 100 and the transport vehicle 200 include devices used to position or self-position estimation, such as GNSS receivers and LiDAR sensors. The controllers of the harvester 100 and the transport vehicle 200 cause the harvester 100 and the transport vehicle 200 to travel automatically based on the position of the harvester 100 and the transport vehicle 200 and the information of the target route. The harvester 100 and the transport vehicle 200 may automatically travel along the target route on a road outside the field (e.g., a farm road or a public road). In that case, the harvester 100 and the transport vehicle 200 automatically travel along the road while utilizing data output from sensors such as cameras, obstacle sensors, and LiDAR sensors.

The management device 600 is a computer that manages the agricultural work performed by the harvester 100 and the transport vehicle 200. The management device 600 may be a server computer that centrally manages information regarding fields, for example, on a cloud and supports agriculture by utilizing data on the cloud. The management device 600, for example, creates a work plan for the harvester 100 and the transport vehicle 200 and causes the harvester 100 and the transport vehicle 200 to perform agricultural work according to the work plan. The management device 600 generates a target route in a field based on information input by a user using the terminal device 400 or another device, for example. The management device 600 may also generate and edit an environment map based on data collected by the harvester 100, the transport vehicle 200, and other mobile devices using sensors such as LiDAR sensors. The management device 600 transmits generated data of the work plan, the target route, and the environment map to the harvester 100 and the transport vehicle 200. The harvester 100 and the transport vehicle 200 automatically move and perform agricultural work based on those data.

The terminal device 400 is a computer used by a user who is in a location remote from the harvester 100 and the transport vehicle 200. The terminal device 400 shown in FIG. 1 is a laptop computer, but there is no limitation thereto. The terminal device 400 may be a stationary computer such as a desktop PC (Personal Computer), or may be a mobile terminal such as a smartphone or a tablet computer. The terminal device 400 can be used to remotely monitor the harvester 100 and the transport vehicle 200, or to remotely operate the harvester 100 and the transport vehicle 200. For example, the terminal device 400 can display on a display the images captured by the cameras (imaging devices) provided on the harvester 100 and the transport vehicle 200. The terminal device 400 can also display on the display a setting screen for a user to input information needed to create a work plan (e.g., a schedule for each agricultural work) for the harvester 100. When a user inputs the information needed on the setting screen and performs a transmission operation, the terminal device 400 transmits the input information to the management device 600. The management device 600 creates a work plan based on the information. The terminal device 400 may also include a function to display on a display a setting screen for a user to input information needed to set a target route.

The configuration and operation of the system according to the present example embodiment will now be described in more detail.

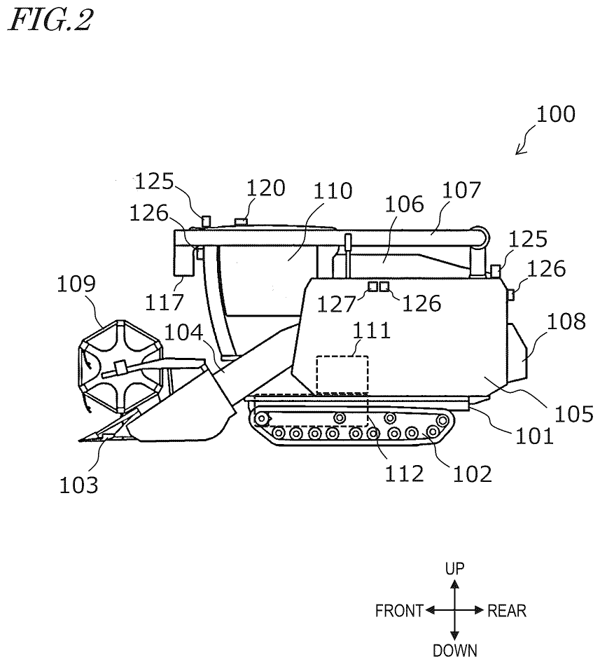

FIG. 2 is a side view schematically showing an example of the harvester 100. The harvester 100 includes a vehicle body 101 and a travel device 102. The illustrated travel device 102 is a crawler-type travel device, but it may also be a travel device that includes wheels with tires. A cabin 110 is provided above the vehicle body 101.

A cutting device 103 that cuts the crop is provided in a height-adjustable manner in front of the travel device 102. A reel 109 to raise the stalk portions of the crop is provided in a height-adjustable manner upward of the cutting device 103. A threshing device 105 and a tank 106 to store the harvested crop are arranged side by side rearward of the cabin 110. The threshing device 105 threshes the harvested crop. The tank 106 stores the harvested crop obtained by threshing the grain, etc. A straw disposal device 108 is provided rearward of the threshing device 105. The straw disposal device 108 finely cuts, and discharges to the outside, the stalk portion, etc., after the harvest, such as grain, has been removed.

A conveyer device 104 is provided between the cutting device 103 and the threshing device 105 to convey the harvested crop. The tank 106 is provided with a discharge device 107 to discharge the harvested crop from the tank 106. The harvested crop is discharged from a discharge outlet 117 at the tip of the cylindrical-shaped discharge device 107 to the outside. The discharge device 107 is capable of an up-down action and a rotation action, and can change the position of the discharge outlet 117. The configuration and the operation of the cutting device 103, the conveyer device 104, the threshing device 105, the discharge device 107, the straw disposal device 108, the reel 109, etc., are known in the art, and the detailed description thereof will be omitted herein.

The harvester 100 of the present example embodiment can operate both in the manual driving mode and in the automated driving mode. In the automated driving mode, the harvester 100 can travel unmanned. In the automated driving mode, the harvester 100 can travel unmanned while performing the operation of harvesting the crop in the field.

As shown in FIG. 2, the harvester 100 includes a prime mover (engine) 111 and a transmission 112. A driver seat, a control lever, an operation terminal, and operation switches are provided inside the cabin 110.

The harvester 100 may include at least one sensor to sense the environment around the harvester 100 and a controller configured or programmed to process the sensing data output from the at least one sensor. The harvester 100 includes a plurality of sensors. The sensors may be LiDAR sensors 125, cameras 126, and obstacle sensors 127.

The cameras 126 may be provided on the front, back, left, and right of the harvester 100, for example. The cameras 126 capture images of the environment around the harvester 100 and generate image data. The images captured by the cameras 126 may be output to the controller mounted on the harvester 100 and may be transmitted to the terminal device 400 for remote monitoring. The images may also be used to monitor the harvester 100 during unmanned driving.

The LiDAR sensors 125 illustrated in FIG. 2 are arranged at the front and rear of the harvester 100. The LiDAR sensors 125 may be further arranged at the side of the harvester 100. The harvester 100 may include a plurality of LiDAR sensors arranged at different positions and in different orientations. The LiDAR sensors 125 may be 3D-LiDAR sensors, but may also be 2D-LiDAR sensors. The LiDAR sensors 125 sense the environment around the harvester 100 and output the sensing data. The LiDAR sensors 125 repeatedly output sensor data representing the distance and direction to measurement points of objects present in the surrounding environment, or the two-dimensional or three-dimensional coordinate values of the measurement points. The sensor data output from the LiDAR sensors 125 are processed by the controller of the harvester 100. The controller can perform self-position estimation for the harvester 100 by matching the sensor data with the environment map. The controller can further detect objects such as obstacles present around the harvester 100 based on the sensor data. The controller may generate or edit an environment map using an algorithm such as SLAM (Simultaneous Localization and Mapping), for example.

The obstacle sensors 127 illustrated in FIG. 2 are arranged on the side of the harvester 100. The obstacle sensors 127 may also be arranged at other locations. For example, the obstacle sensors 127 may be arranged at the front and rear of the harvester 100. The obstacle sensors 127 may include, for example, a laser scanner or an ultrasonic sonar. The obstacle sensors 127 are used to detect obstacles in the surroundings during automated travel and to stop or detour the harvester 100. The LiDAR sensors 125 may be used as one of the obstacle sensors 127.

The harvester 100 further includes a GNSS unit 120. The GNSS unit 120 includes a GNSS receiver. The GNSS receiver may include an antenna that receives signals from GNSS satellites and a processor configured or programmed to calculate the position of the harvester 100 based on the signals received by the antenna. The GNSS unit 120 receives satellite signals transmitted from a plurality of GNSS satellites and performs positioning based on the satellite signals. GNSS is a generic term for satellite positioning systems such as GPS (Global Positioning System), QZSS (Quasi-Zenith Satellite System, e.g., MICHIBIKI), GLONASS, Galileo, and BeiDou. While the GNSS unit 120 of the present example embodiment is provided at the top of the cabin 105, it may be provided at other locations.

The GNSS unit 120 may include an inertial measurement unit (IMU). Position data may be complemented using signals from the IMU. The IMU can measure the tilt and minute movements of the harvester 100. Using data acquired by the IMU, the positioning performance can be improved by complementing the position data based on the satellite signals.

The controller of the harvester 100 may use the sensing data acquired by sensors such as the cameras 126 and/or the LiDAR sensors 125 in addition to the positioning results by the GNSS unit 120 for positioning. If there are geographic objects that function as characteristic points in the environment in which the harvester 100 is traveling, the position and orientation of the harvester 100 can be estimated with high precision based on data acquired by the cameras 126 and/or the LiDAR sensors 125 and the environment map stored in the storage device in advance. By correcting or complementing the position data based on satellite signals using data acquired by the cameras 126 and/or the LiDAR sensors 125, it is possible to identify the position of the harvester 100 with higher precision.

The prime mover 111 may be a diesel engine, for example. An electric motor may be used instead of a diesel engine. The transmission 112 can vary the propulsion and traveling speed of the harvester 100 by changing the gear. The transmission 112 can also switch between forward and reverse for the harvester 100.

In an example embodiment where the harvester 100 includes the crawler-type travel device 102, the traveling direction of the harvester 100 can be changed by making the rotation speeds of the left wheels and the right wheels with an endless track attached thereto different from each other, or by making the rotation directions of the left wheels and the right wheels different from each other. In an example embodiment where the harvester 100 includes a travel device having wheels with tires, the harvester 100 includes a power steering device, and the travel direction of the harvester 100 can be changed by controlling the power steering device to change the steer angle (also referred to as the “steering angle”) of the steering wheel.

While the harvester 100 shown in FIG. 2 is compatible with human driving, the harvester 100 may be compatible only with unmanned driving. In that case, the harvester 100 may not include elements required only for human driving, such as the cabin 110, the steering device, and the driver seat. The unmanned harvester 100 can travel autonomously or by remote control by a user.

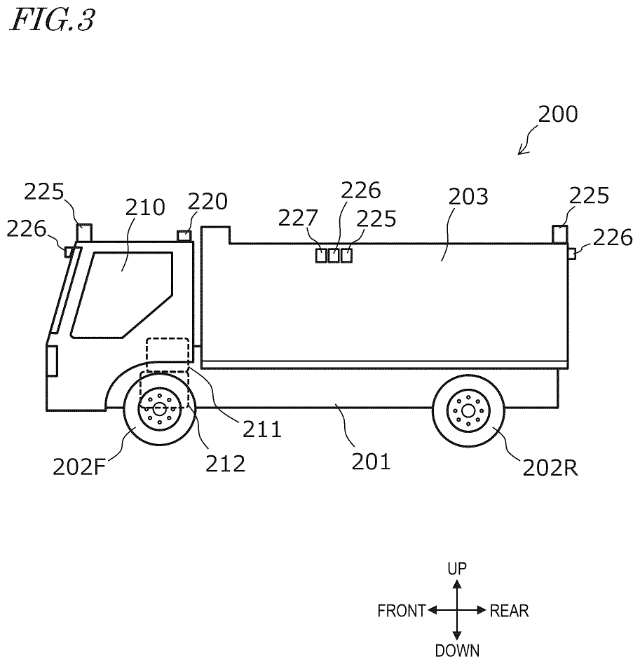

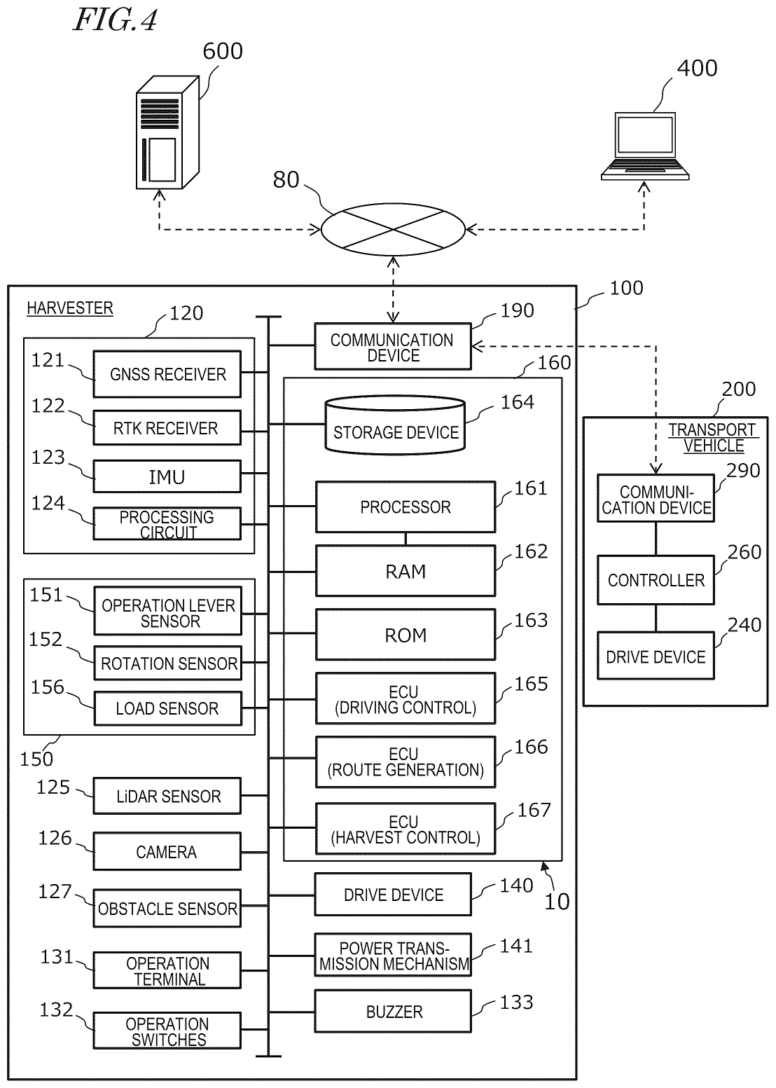

FIG. 3 is a side view schematically showing an example of the transport vehicle 200. The transport vehicle 200 of the present example embodiment can operate both in the manual driving mode and in the automated driving mode. In the automated driving mode, the transport vehicle 200 can travel unmanned.

As shown in FIG. 3, the transport vehicle 200 includes a vehicle body 201, a prime mover (engine) 211, a transmission 212, a cabin 210, and a load bed 203. The vehicle body 201 includes wheels 202 with tires. The wheels 202 include a pair of front wheels 202F and a pair of rear wheels 202R. One or both of the front wheels 202F and the rear wheels 202R may be a plurality of wheels (crawlers) with an endless track attached thereto, rather than wheels with tires. A driver seat, a steering device, an operation terminal, and operation switches are provided inside the cabin 210.

The transport vehicle 200 may include a sensor that senses the environment around the transport vehicle 200 and a controller that processes the sensing data output from the sensor. The transport vehicle 200 includes a plurality of sensors. The sensor may be LiDAR sensors 225, cameras 226, and obstacle sensors 227.

The cameras 226 may be provided on the front, back, left, and right of the transport vehicle 200, for example. The cameras 226 capture images of the environment around the transport vehicle 200 and generate image data. The images captured by the cameras 226 may be output to the controller mounted on the transport vehicle 200 and may be transmitted to the terminal device 400 for remote monitoring. The images may also be used to monitor the transport vehicle 200 during unmanned driving.

The transport vehicle 200 may include a plurality of LiDAR sensors arranged at different positions and in different orientations. The LiDAR sensors 225 illustrated in FIG. 3 are provided on the front, back, left, and right of the transport vehicle 200. The LiDAR sensors 225 may be 3D-LiDAR sensors, but may also be 2D-LiDAR sensors. The LiDAR sensors 225 sense the environment around the transport vehicle 200 and output the sensing data. The LiDAR sensors 225 repeatedly output sensor data representing the distance and direction to measurement points of objects present in the surrounding environment, or the three-dimensional or two-dimensional coordinate values of the measurement points. The sensor data output from the LiDAR sensors 225 are processed by the controller of the transport vehicle 200. The controller can perform self-position estimation for the transport vehicle 200 by matching the sensor data with the environment map. The controller can further detect objects such as obstacles present around the transport vehicle 200. The controller can generate or edit an environment map using an algorithm such as SLAM, for example.

The obstacle sensor 227 illustrated in FIG. 3 is arranged on the side of the transport vehicle 200. The obstacle sensor 227 may also be arranged at other locations. For example, the obstacle sensor 227 may be arranged at the front and rear of the transport vehicle 200. The obstacle sensor 227 may include, for example, a laser scanner or an ultrasonic sonar. The obstacle sensor 227 is used to detect obstacles in the surroundings during automated travel and to stop or detour the transport vehicle 200. The LiDAR sensors 225 may be used as one of the obstacle sensors 227.

The transport vehicle 200 further includes a GNSS unit 220. The GNSS unit 220 includes a GNSS receiver. The GNSS receiver may include an antenna that receives signals from GNSS satellites and a processor that calculates the position of the transport vehicle 200 based on the signals received by the antenna. The GNSS unit 220 receives satellite signals transmitted from a plurality of GNSS satellites and performs positioning based on the satellite signals. While the GNSS unit 220 of the present example embodiment is provided at the top of the cabin 210, it may be provided at other locations.

The GNSS unit 220 may include an IMU, and position data can be complemented using signals from the IMU. The IMU can measure the tilt and minute movements of the transport vehicle 200. Using data acquired by the IMU, the positioning performance can be improved by complementing the position data based on the satellite signals.

The controller of the transport vehicle 200 may use the sensing data acquired by sensors such as the cameras 226 and/or the LiDAR sensors 225 in addition to the positioning results by the GNSS unit 220. If there are geographic objects that function as characteristic points in the environment in which the transport vehicle 200 is traveling, the position and orientation of the transport vehicle 200 can be estimated with high precision based on data acquired by the cameras 226 and/or the LiDAR sensor 225 and the environment map stored in the storage device in advance. By correcting or complementing the position data based on satellite signals using data acquired by the cameras 226 and/or the LiDAR sensor 225, it is possible to identify the position of the transport vehicle 200 with higher precision.

The prime mover 211 may be a diesel engine, for example. An electric motor may be used instead of a diesel engine. The transmission 212 can vary the propulsion and traveling speed of the transport vehicle 200 by changing the gear. The transmission 212 can also switch between forward and reverse for the transport vehicle 200.

The steering device provided in the transport vehicle 200 includes a steering wheel, a steering shaft connected to the steering wheel, and a power steering device that assists the steering by the steering wheel. The front wheels 202F are steering wheels, and it is possible to change the direction of travel of the transport vehicle 200 by changing the steer angle (steering angle). The steering angle of the front wheels 202F can be changed by operating the steering wheel. The power steering device includes a hydraulic device or an electric motor that supplies auxiliary power to change the steering angle of the front wheels 202F. When automatic steering is performed, the steering angle is automatically adjusted by the force from the hydraulic device or the electric motor as controlled by the controller arranged in the transport vehicle 200.

While the transport vehicle 200 shown in FIG. 3 is compatible with human driving, the transport vehicle 200 may be compatible only with unmanned driving. In that case, the transport vehicle 200 may not include elements required only for human driving, such as the cabin 210, the steering device, and the driver seat. The unmanned transport vehicle 200 can travel autonomously or by remote control by a user.

FIG. 4 is a block diagram showing an example configuration of the harvester 100. The harvester 100 can communicate with the terminal device 400 and the management device 600 via the network 80. The harvester 100 and the transport vehicle 200 may communicate with each other via the network 80, or may communicate directly with each other without the network 80.

The harvester 100 illustrated in FIG. 4 includes the GNSS unit 120, the LiDAR sensors 125, the cameras 126, the obstacle sensors 127, an operation terminal 131, operation switches 132, a buzzer 133, a drive device 140, a power transmission mechanism 141, sensors 150, a controller 160, and a communication device 190. These elements are connected to each other so that the elements can communicate with each other via a bus.

The GNSS unit 120 includes a GNSS receiver 121, an RTK receiver 122, an inertial measurement unit (IMU) 123, and a processing circuit 124. The sensors 150 detect various states of the harvester 100. The sensors 150 include an operation lever sensor 151, a rotation sensor 152, and a load sensor 156. The controller 160 includes a processor 161, a RAM (Random Access Memory) 162, a ROM (Read Only Memory) 163, a storage device 164, and a plurality of electronic control units (ECUs) 165 to 167. The transport vehicle 200 includes a drive device 240, a controller 260, and a communication device 290. FIG. 4 shows the elements that are relatively highly relevant to the automated driving operation by the harvester 100, and the other elements are not shown in the figure.

The GNSS receiver 121 provided in the GNSS unit 120 receives satellite signals transmitted from a plurality of GNSS satellites and generates GNSS data based on the satellite signals. The GNSS data is generated in a predetermined format, such as the NMEA-0183 format. The GNSS data may include, for example, values indicating the identification numbers, elevation angles, azimuth angles, and reception strength of satellites from which satellite signals are received.

The GNSS unit 120 illustrated in FIG. 4 performs positioning of the harvester 100 using RTK (Real Time Kinematic)-GNSS. With the positioning using RTK-GNSS, correction signals transmitted from a reference station are used, in addition to the satellite signals transmitted from a plurality of GNSS satellites. The reference station may be installed near the field where the harvester 100 performs a tasked travel (e.g., within 10 km of the harvester 100). The reference station generates a correction signal in RTCM format, for example, based on satellite signals received from a plurality of GNSS satellites, and transmits the correction signal to the GNSS unit 120. The RTK receiver 122 includes an antenna and a modem, and receives the correction signal transmitted from the reference station. The processing circuit 124 of the GNSS unit 120 corrects the positioning results by the GNSS receiver 121 based on the correction signal. Using RTK-GNSS, it is possible to perform positioning with a precision of a few centimeters, for example. Position data including information of latitude, longitude and altitude is acquired through high-precision positioning using RTK-GNSS. The GNSS unit 120 calculates the position of the harvester 100 at a frequency of about 1 to 10 times per second, for example.

Note that the positioning method is not limited to RTK-GNSS, and any positioning method may be used (such as interferometric positioning or relative positioning) as long as position data of the required precision is obtained. For example, positioning using VRS (Virtual Reference Station) or DGPS (Differential Global Positioning System) may be used. If position data of the required precision can be obtained without using the correction signal transmitted from the reference station, the position data may be generated without using the correction signal. In that case, the GNSS unit 120 may not include the RTK receiver 122.

Even when RTK-GNSS is used, in places where correction signals from the reference station cannot be obtained (e.g., on roads far from the field), the position of the harvester 100 is estimated by other methods, not by signals from the RTK receiver 122. For example, the position of the harvester 100 can be estimated by matching data output from the LiDAR sensor 125 and/or the camera 126 with a high-precision environment map.

The IMU 123 may include a 3-axis accelerometer or a 3-axis gyroscope. The IMU 123 may include a compass sensor such as a 3-axis geomagnetic sensor. The IMU 123 functions as a motion sensor and can output signals indicating various quantities such as acceleration, speed, displacement, and attitude of the harvester 100. The processing circuit 124 can estimate the position and orientation of the harvester 100 with higher precision based on the signals output from the IMU 123 in addition to the satellite signals and the correction signals. The signals output from the IMU 123 can be used to correct or complement the position calculated based on the satellite signals and the correction signals. The IMU 123 outputs signals at a higher frequency than the GNSS receiver 121. Using the signals output at a higher frequency, the processing circuit 124 can measure the position and orientation of the harvester 100 at a higher frequency (e.g., 10 Hz or more). Instead of the IMU 123, a 3-axis accelerometer and a 3-axis gyroscope may be provided separately. The IMU 123 may be provided as a device separate from the GNSS unit 120.

The camera 126 is an imaging device that captures images of the environment around the harvester 100. The camera 126 includes an image sensor, such as a CCD (Charge Coupled Device) or CMOS (Complementary Metal Oxide Semiconductor). The camera 126 may also include an optical system including one or more lenses and a signal processing circuit. The camera 126 captures images of the environment around the harvester 100 while the harvester 100 is traveling, and generates image (e.g., video) data. The camera 126 may capture a video at a frame rate of 3 frames/sec (fps: frames per second) or more, for example. The images generated by the camera 126 can be used, for example, for a person monitoring remotely to check the environment around the harvester 100 using the terminal device 400. The images generated by the camera 126 may be used for positioning or obstacle detection. A plurality of cameras 126 may be provided at different locations of the harvester 100, or a single camera may be provided. A visible light camera that generates visible light images and an infrared camera that generates infrared images may be provided separately. Both a visible light camera and an infrared camera may be provided as cameras that generate images for monitoring. The infrared camera may also be used to detect obstacles at night.

The obstacle sensor 127 detects objects that are present around the harvester 100. The obstacle sensor 127 may include, for example, a laser scanner or an ultrasonic sonar. The obstacle sensor 127 outputs a signal indicating that an obstacle exists when an object exists within a predetermined distance from the obstacle sensor 127. A plurality of obstacle sensors 127 may be arranged at different locations of the harvester 100. For example, a plurality of laser scanners and a plurality of ultrasonic sonars may be arranged at different locations of the harvester 100. By including a plurality of obstacle sensors 127, it is possible to reduce blind spots in monitoring obstacles around the harvester 100.

The operation lever sensor 151 detects an operation of an operation lever by a user in the cabin 110. The output signal of the operation lever sensor 151 is used for the driving control by the controller 160. The rotation sensor 152 measures the rotation speed, i.e., the number of rotations per unit time, of the axle of the travel device 102. The rotation sensor 152 may be a sensor that uses a magnetoresistive element (MR), a Hall element, or an electromagnetic pickup, for example. The rotation sensor 152 outputs a value indicating the number of rotations per minute (unit: rpm) of the axle, for example. The rotation sensor 152 is used to measure the speed of the harvester 100, for example.

The load sensor 156 is provided at the bottom of the tank 106 and detects the weight of the harvested crop in the tank 106. By detecting the weight of the harvested crop in the tank 106, the controller 160 can recognize the storage status of the harvested crop in the tank 106. A yield sensor and a taste sensor may be provided inside or around the tank 106. The taste sensor outputs data such as the moisture content and protein content of the harvested crop as quality data.

The buzzer 133 is a sound output device that emits warning sounds to notify of abnormalities. The buzzer 133, for example, emits a warning sound when an obstacle is detected during automated driving. The buzzer 220 is controlled by the controller 160.

The drive device 140 includes various devices necessary to drive the harvester 100, such as the prime mover 111 and the transmission 112. The prime mover 111 may include an internal combustion engine, such as a diesel engine. The drive device 140 may include an electric motor for traction instead of or in addition to the internal combustion engine.

The power transmission device 141 transmits the power generated by the prime mover 111 to various devices that perform the harvesting operation. The devices that perform the harvesting operation include the cutting device 103, the conveyer device 104, the threshing device 105, the discharge device 107, the straw disposal device 108, the reel 109, etc. The harvester 100 may include a power source (e.g., an electric motor) that supplies power to at least one of these devices that perform the harvesting operation, separate from the prime mover 111.

The processor 161 may be a semiconductor integrated circuit including a central processing unit (CPU), for example. The processor 161 may be implemented by a microprocessor or a microcontroller. Alternatively, the processor 161 may be implemented by an FPGA (Field Programmable Gate Array) with a CPU, a GPU (Graphics Processing Unit), an ASIC (Application Specific Integrated Circuit), an ASSP (Application Specific Standard Product), or a combination of two or more circuits selected from among these circuits. The processor 161 sequentially executes a computer program stored in the ROM 163 that describes a group of instructions for executing at least one process, thus realizing the desired process.

The ROM 163 is, for example, a writable memory (e.g., a PROM), a rewritable memory (e.g., a flash memory), or a read-only memory. The ROM 163 stores a program that controls the operation of the processor 161. The ROM 163 does not need to be a single storage medium, and may be a collection of storage mediums. Some of the collection of storage mediums may be removable memory.

The RAM 162 provides a work area for temporarily expanding the control program stored in the ROM 163 at boot. The RAM 162 does not need to be a single storage medium, and may be a collection of storage mediums.

The storage device 164 includes one or more storage medium such as a flash memory or a magnetic disk. The storage device 164 stores various data generated by the GNSS unit 120, the LiDAR sensor 125, the camera 126, the obstacle sensor 127, the sensors 150, and the controller 160. The data stored in the storage device 164 may include map data (environment map) of the environment in which the harvester 100 travels, and data of a target route for automated driving. The environment map includes information on the plurality of fields in which the harvester 100 performs agricultural work and the roads around the fields. The environment map and the target route may be generated by the processor of the management device 600. Note that the controller 160 may have the function of generating or editing the environment map and the target route. The controller 160 can edit the environment map and the target route acquired from the management device 600 in accordance with the environment in which the harvester 100 travels. The storage device 164 also stores data of the work plan received by the communication device 190 from the management device 600.

The storage device 164 also stores computer programs that cause the processor 161 and the ECUs 165 to 167 to perform various operations to be described below. Such computer programs may be provided to the harvester 100 via a storage medium (e.g., a semiconductor memory or an optical disc) or an electrical communication line (e.g., the Internet). Such computer programs may be sold as commercial software.

The controller 160 is configured or programmed to include a plurality of ECUs 165 to 167. The ECU 165 controls the traveling speed and the turn operation of the harvester 100 by controlling the prime mover 111, the transmission 112, the travel device 102, etc., included in the drive device 140.

The ECU 165 performs calculation and control to achieve automated driving based on data output from the GNSS unit 120, the camera 126, the obstacle sensor 127, the LiDAR sensor 125, the sensors 150, and the processor 161. For example, the ECU 165 identifies the position of the harvester 100 based on data output from at least one of the GNSS unit 120, the camera 126, and the LiDAR sensor 125. Inside the field, the ECU 165 may determine the position of the harvester 100 based only on data output from the GNSS unit 120. The ECU 165 may estimate or correct the position of the harvester 100 based on data acquired by the camera 126 and/or the LiDAR sensor 125. Using the data acquired by the camera 126 and/or the LiDAR sensor 125, it is possible to further improve the positioning precision. For example, the ECU 165 may estimate the position of the harvester 100 by matching data output from the LiDAR sensor 125 and/or the camera 126 with an environment map. During automated driving, the ECU 165 performs necessary calculations to enable the harvester 100 to travel along the target route based on the estimated position of the harvester 100.

The ECU 166 may determine the destination of the harvester 100 based on the work plan stored in the storage device 164, and determine the target route from the travel starting point to the destination point of the harvester 100. The ECU 166 may perform the process of detecting objects located around the harvester 100 based on data output from the camera 126, the obstacle sensor 127, and the LiDAR sensor 125.

The ECU 167 controls the operation of the power transmission mechanism 141, etc., so as to cause various devices to perform the harvesting operation described above to execute desired operations.

The controller 160 achieves automated driving and crop harvesting operation by the operation of these ECUs. During automated driving, the controller 160 is configured or programmed to control the drive device 140 based on the measured or estimated position of the harvester 100 and the target route. Thus, the controller 160 can cause the harvester 100 to travel along the target route.

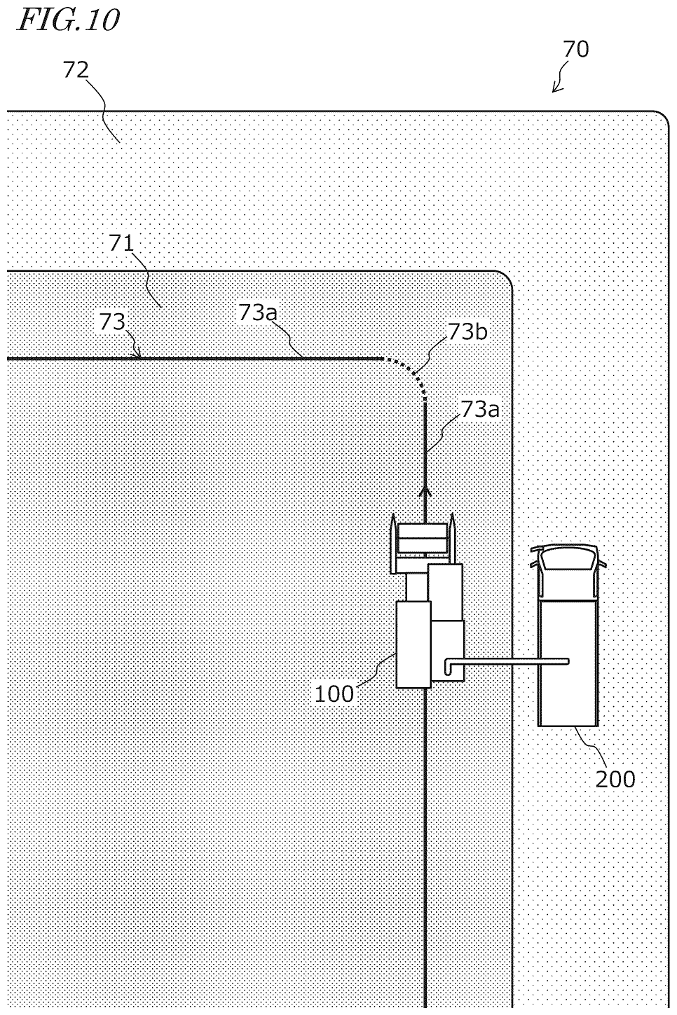

The plurality of ECUs included in the controller 160 can communicate with each other according to a vehicle bus standard, such as CAN (Controller Area Network), for example. Instead of CAN, a faster communication method, such as in-vehicle Ethernet (registered trademark), may be used. In FIG. 10, the ECUs 165 to 167 are each shown as an individual block, but their functions may each be implemented by a plurality of ECUs. An in-vehicle computer that integrates at least some of the functions of the ECUs 165 to 167 may be provided. The controller 180 may include ECUs other than the ECUs 165 to 167, and any number of ECUs may be provided according to the functions. Each ECU may include a processing circuit that includes one or more processors. The processor 161 may be integrated with any of the ECUs included in the controller 160.

The communication device 190 is a device that includes a circuit to communicate with the transport vehicle 200, the terminal device 400, and the management device 600. The communication device 190 includes a circuit to wirelessly communicate with the communication device 290 of the transport vehicle 200. Thus, it is possible to cause the transport vehicle 200 to execute desired operations, and acquire information from the transport vehicle 200. The communication device 190 may further include an antenna and a communication circuit to exchange signals via the network 80 with the communication devices of the terminal device 400 and the management device 600. The network 80 may include a cellular mobile communication network such as 3G, 4G, or 5G, and the Internet, for example. The communication device 190 may include the function of communicating with a mobile terminal used by a monitoring person who is in the vicinity of the harvester 100. Communication with such a mobile terminal may be in accordance with any wireless communication standard, such as Wi-Fi (registered trademark), cellular mobile communication such as 3G, 4G, or 5G, or Bluetooth (registered trademark).

The operation terminal 131 is a terminal for a user to perform operations related to the travel of the harvester 100 and the action of the transport vehicle 200, and is also referred to as a virtual terminal (VT). The operation terminal 131 may include a display device such as a touch screen and/or one or more buttons. The display device may be a display such as an LCD or an organic light-emitting diode (OLED), for example. By operating the operation terminal 131, a user can perform various operations, such as switching the automated driving mode on and off, recording or editing an environment map, and setting a target route. At least some of these operations may also be realized by operating operation switches 132. The operation terminal 131 may be configured to be detachable from the harvester 100. A user located away from the harvester 100 may control the operation of the harvester 100 by operating the detached operation terminal 131. A user may control the operation of the harvester 100 by operating a computer, such as the terminal device 400, on which the necessary application software is installed, instead of the operation terminal 131.

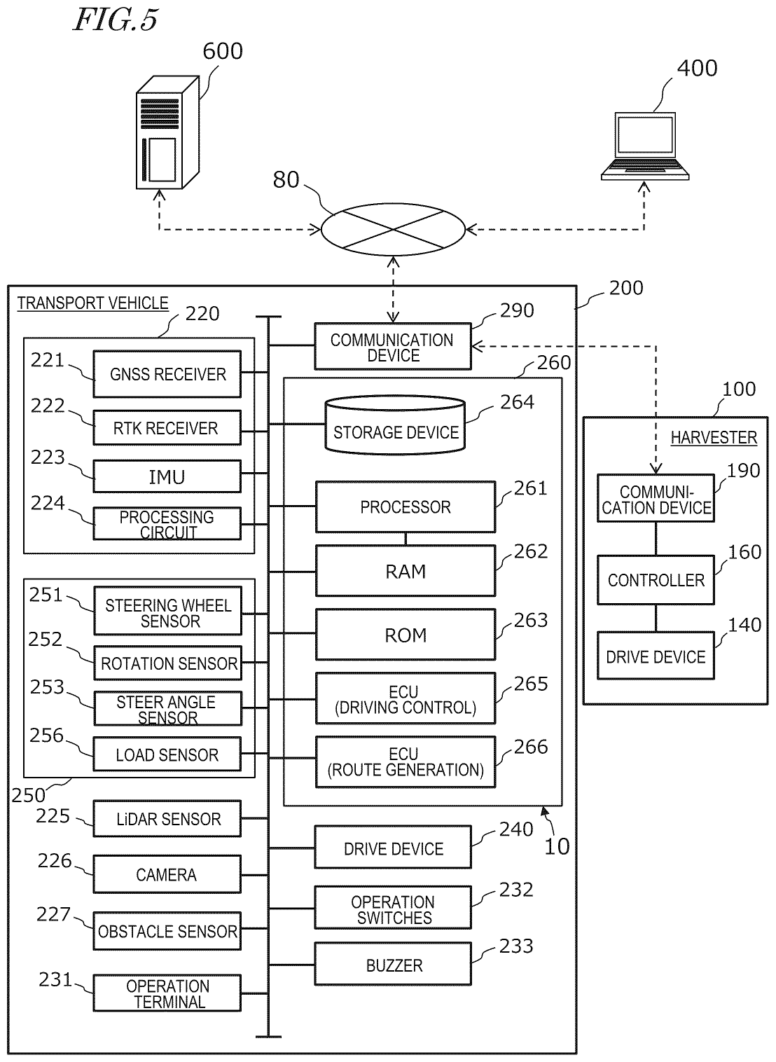

FIG. 5 is a block diagram showing an example configuration of the transport vehicle 200. The transport vehicle 200 can communicate with the terminal device 400 and the management device 600 via the network 80.

The transport vehicle 200 illustrated in FIG. 5 includes the GNSS unit 220, the LiDAR sensor 225, the camera 226, the obstacle sensor 227, an operation terminal 231, operation switches 232, a buzzer 233, the drive device 240, sensors 250, the controller 260, and the communication device 290. These elements are connected to each other so that the elements can communicate with each other via a bus.

The GNSS unit 220 includes a GNSS receiver 221, an RTK receiver 222, an IMU 223, and a processing circuit 224. The sensors 250 detect various states of the transport vehicle 200. The sensors 250 include a steering wheel sensor 251, a rotation sensor 252, a steer angle sensor 253, and a load sensor 256. The controller 260 includes a processor 261, a RAM 262, a ROM 263, a storage device 264, electronic control units (ECU) 265 and 266. FIG. 5 shows elements that are relatively highly relevant to the automated driving operation by the transport vehicle 200, and the other elements are not shown in the figure.

The GNSS receiver 221 provided in the GNSS unit 220 receives satellite signals transmitted from a plurality of GNSS satellites and generates GNSS data based on the satellite signals.

The GNSS unit 220 illustrated in FIG. 5 performs positioning of the transport vehicle 200 using RTK-GNSS. Using RTK-GNSS, it is possible to perform positioning with a precision of a few centimeters, for example. Position data including latitude, longitude and altitude is acquired through high-precision positioning using RTK-GNSS. The GNSS unit 220 calculates the position of the transport vehicle 200 at a frequency of about 1 to 10 times per second, for example.

Note that the positioning method is not limited to RTK-GNSS, and any positioning method may be used (such as interferometric positioning or relative positioning) as long as position data of the required precision is obtained. For example, positioning using VRS or DGPS may be used. If position data of the required precision can be obtained without using the correction signal transmitted from the reference station, the position data may be generated without using the correction signal. In that case, the GNSS unit 220 may not include the RTK receiver 222.

Even when RTK-GNSS is used, in places where correction signals from the reference station cannot be obtained (e.g., on roads far from the field), the position of the transport vehicle 200 is estimated by other methods, not by signals from the RTK receiver 222. For example, the position of the transport vehicle 200 can be estimated by matching data output from the LiDAR sensor 225 and/or the camera 226 with a high-precision environment map.

The IMU 223 may include a 3-axis accelerometer and a 3-axis gyroscope. The IMU 223 may include a compass sensor such as a 3-axis geomagnetic sensor. The IMU 223 functions as a motion sensor and can output signals indicating various quantities such as acceleration, speed, displacement, and attitude of the transport vehicle 200. The processing circuit 224 can estimate the position and orientation of the transport vehicle 200 with higher precision based on the signals output from the IMU 223 in addition to the satellite signals and the correction signals. The signals output from the IMU 223 can be used to correct or complement the position calculated based on the satellite signals and the correction signal. The IMU 223 outputs signals at a higher frequency than the GNSS receiver 221. Using the signals output at a higher frequency, the processing circuit 224 can measure the position and orientation of the transport vehicle 200 at a higher frequency (e.g., 10 Hz or more). Instead of the IMU 223, a 3-axis accelerometer and a 3-axis gyroscope may be provided separately. The IMU 223 may be provided as a device separate from the GNSS unit 220.

The camera 226 is an imaging device that captures images of the environment around the transport vehicle 200. The camera 226 includes an image sensor, such as a CCD or CMOS. The camera 226 may also include an optical system including one or more lenses and a signal processing circuit. The camera 226 captures images of the environment around the transport vehicle 200 while the transport vehicle 200 is traveling, and generates image (e.g., video) data. The camera 226 may capture a video at a frame rate of 3 (fps) or more. The images generated by the camera 226 can be used, for example, for a person monitoring remotely to check the environment around the transport vehicle 200 using the terminal device 400. The images generated by the camera 226 may be used for positioning or obstacle detection. A plurality of cameras 226 may be provided at different locations of the transport vehicle 200, or a single camera may be provided. A visible light camera that generates visible light images and an infrared camera that generates infrared images may be provided separately. Both a visible light camera and an infrared camera may be provided as cameras that generate images for monitoring. The infrared camera may also be used to detect obstacles at night.

The obstacle sensor 227 detects objects that are present around the transport vehicle 200. The obstacle sensor 227 may include, for example, a laser scanner or an ultrasonic sonar. A plurality of obstacle sensors 227 may be provided at different locations of the transport vehicle 200. For example, a plurality of laser scanners and a plurality of ultrasonic sonars may be arranged at different locations of the transport vehicle 200. By including a plurality of obstacle sensors 227, it is possible to reduce blind spots in monitoring obstacles around the transport vehicle 200.

The steering wheel sensor 251 measures the rotation angle of the steering wheel of the transport vehicle 200. The steer angle sensor 253 measures the steer angle of the front wheels 202F, which are steering wheels. The measurement values taken by the steering wheel sensor 251 and the steer angle sensor 253 are used for steering control by the controller 260.

The rotation sensor 252 measures the rotational speed, i.e., the number of rotations per unit time, of the axle connected to the wheels 202. The rotation sensor 252 may be a sensor that uses a magnetoresistive element (MR), a Hall element, or an electromagnetic pickup, for example. The rotation sensor 252 outputs a value indicating the number of rotations per minute (unit: rpm) of the axle, for example. The rotation sensor 252 is used to measure the speed of the transport vehicle 200.

The load sensor 256 is provided at the bottom of the load bed 203, which functions as a container to store the harvested crop, and detects the weight of the harvested crop in the load bed 203. By detecting the weight of the harvested crop in the load bed 203, the controller 260 can recognize the storage status of the harvested crop in the load bed 203.

The buzzer 233 is a sound output device that emits warning sounds to notify of abnormalities. For example, the buzzer 133 emits a warning sound when an obstacle is detected during automated driving. The buzzer 233 is controlled by the controller 260.

The drive device 240 includes various devices necessary for driving the transport vehicle 200, such as the prime mover 211 and the transmission 212. The prime mover 211 may include an internal combustion engine, such as a diesel engine. The drive device 240 may include an electric motor for traction instead of or in addition to the internal combustion engine.

The processor 261 may be a semiconductor integrated circuit including a central processing unit (CPU), for example. The ROM 263 is, for example, a writable memory (e.g., a PROM), a rewritable memory (e.g., a flash memory), or a read-only memory. The RAM 262 provides a work area for temporarily expanding the control program stored in the ROM 263 at boot. The detailed configuration of the processor 261, the RAM 262, and the ROM 263 is similar to the processor 161, the RAM 162, and the ROM 163, and the detailed description thereof will be omitted herein.

The storage device 264 includes one or more storage medium such as a flash memory or a magnetic disk. The storage device 264 stores various data generated by the GNSS unit 220, the LiDAR sensor 225, the camera 226, the obstacle sensor 227, the sensors 250, and the controller 260. The data stored in the storage device 264 may include map data (environment map) of the environment in which the transport vehicle 200 travels, and data of a target route for automated driving. The environment map includes information on the plurality of fields in which the transport vehicle 200 performs agricultural work and the roads around the fields. The environment map and the target route may be generated by the processor of the management device 600. Note that the controller 160 may have the function of generating or editing the environment map and the target route. The controller 260 can edit the environment map and the target route acquired from the management device 600 in accordance with the environment in which the transport vehicle 200 travels. The storage device 264 also stores data of the work plan received by the communication device 290 from the management device 600.

The storage device 264 also stores computer programs that cause the processor 261 and the ECUs 265, 266 to perform various operations to be described below. Such computer programs may be provided to the transport vehicle 200 via a storage medium (e.g., a semiconductor memory or an optical disc) or an electrical communication line (e.g., the Internet). Such computer programs may be sold as commercial software.

The controller 260 includes the ECUs 265, 266. The ECU 265 controls the traveling speed and the turn operation of the transport vehicle 200 by controlling the prime mover 211, the transmission 212, the steering device, etc., included in the drive device 240.

The ECU 265 performs calculation and control to achieve automated driving based on data output from the GNSS unit 220, the camera 226, the obstacle sensor 227, the LiDAR sensor 225, the sensors 250, and the processor 261. For example, the ECU 265 identifies the position of the transport vehicle 200 based on data output from at least one of the GNSS unit 220, the camera 226, and the LiDAR sensor 225. Inside the field, the ECU 265 may determine the position of the transport vehicle 200 based only on data output from the GNSS unit 220. The ECU 265 may estimate or correct the position of the transport vehicle 200 based on data acquired by the camera 226 and/or the LiDAR sensor 225. Using the data acquired by the camera 226 and/or the LiDAR sensor 225, it is possible to further improve the positioning precision. For example, the ECU 265 may estimate the position of the transport vehicle 200 by matching data output from the LiDAR sensor 225 and/or the camera 226 with an environment map. During automated driving, the ECU 265 performs necessary calculations to enable the transport vehicle 200 to travel along the target route based on the estimated position of the transport vehicle 200.

The ECU 266 may determine the destination of the transport vehicle 200 based on the work plan stored in the storage device 264, and determine the target route from the travel starting point to the destination point of the transport vehicle 200. The ECU 266 may perform the process of detecting objects located around the transport vehicle 200 based on data output from the LiDAR sensor 225, the camera 226, and the obstacle sensor 227.

The controller 260 achieves automated driving by the operation of these ECUs 265, 266. During automated driving, the controller 260 controls the drive device 240 based on the measured or estimated position of the transport vehicle 200 and the target route. Thus, the controller 260 can cause the transport vehicle 200 to travel along the target route.

The plurality of ECUs included in the controller 260 can communicate with each other according to a vehicle bus standard, such as CAN, for example. Instead of CAN, a faster communication method, such as in-vehicle Ethernet (registered trademark), may be used. In FIG. 5, the ECUs 265, 266 are each shown as an individual block, but their functions may each be implemented by a plurality of ECUs. An in-vehicle computer that integrates at least some of the functions of the ECUs 265, 266 may be provided. The controller 260 may include ECUs other than the ECUs 265, 266, and any number of ECUs may be provided according to the functions. Each ECU includes a processing circuit that includes one or more processors. The processor 261 may be integrated with any of the ECUs included in the controller 260.

The communication device 290 is a device that includes a circuit to communicate with the harvester 100, the terminal device 400, and the management device 600. The communication device 290 includes a circuit to wirelessly communicate with the communication device 190 of the harvester 100. Thus, it is possible to cause the harvester 100 to execute desired operations, and acquire information from the harvester 100. The communication device 290 may further include an antenna and a communication circuit to exchange signals via the network 80 with the communication devices of the terminal device 400 and the management device 600. The communication device 290 may include the function of communicating with a mobile terminal used by a monitoring person who is in the vicinity of the transport vehicle 200. Communication with such a mobile terminal may be in accordance with any wireless communication standard, such as Wi-Fi (registered trademark), cellular mobile communication such as 3G, 4G, or 5G, or Bluetooth (registered trademark).

The operation terminal 231 is a terminal for a user to perform operations related to the travel of the transport vehicle 200, and is also referred to as a virtual terminal (VT). The operation terminal 231 may include a display device such as a touch screen and/or one or more buttons. The display device may be a display such as an LCD or an OLED, for example. By operating the operation terminal 231, a user can perform various operations, such as switching the automated driving mode on and off, recording or editing an environment map, and setting a target route. At least some of these operations may also be realized by operating operation switches 232. The operation terminal 231 may be configured to be detachable from the transport vehicle 200. A user located away from the transport vehicle 200 may control the operation of the transport vehicle 200 by operating the detached operation terminal 231. A user may control the operation of the transport vehicle 200 by operating a computer, such as the terminal device 400, on which the necessary application software is installed, instead of the operation terminal 231.

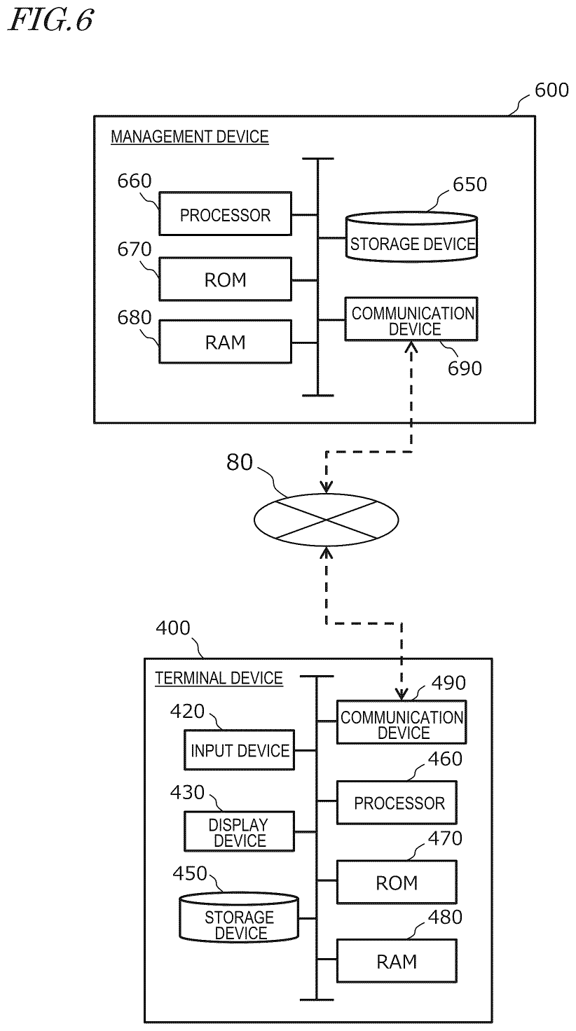

Next, referring to FIG. 6, the configuration of the management device 600 and the terminal device 400 will be described. FIG. 6 is a block diagram illustrating an example hardware configuration of the management device 600 and the terminal device 400.

The management device 600 includes the storage device 650, the processor 660, the ROM 670, the RAM 680, and the communication device 690. These elements are connected to each other so that the elements can communicate with each other via a bus. The management device 600 can function as a cloud server that manages the schedule of agricultural work performed in the field by the harvester 100 and the transport vehicle 200 and supports agriculture by using the data the management device 600 manages. A user can use the terminal device 400 to input the information needed to create a work plan and upload that information to the management device 600 via the network 80. The management device 600 can create a schedule for agricultural work, i.e., a work plan, based on that information. The management device 600 can also generate or edit an environment map. The environment map may be delivered from a computer external to the management device 600.

The communication device 690 is a communication module to communicate with the harvester 100, the transport vehicle 200, and the terminal device 400 via the network 80. The communication device 690 can perform wired communication in conformity with communication standards such as IEEE1394 (registered trademark) or Ethernet (registered trademark), for example. The communication device 690 may perform wireless communication in conformity with the Bluetooth (registered trademark) standard or the Wi-Fi standard, or cellular mobile communication such as 3G, 4G, or 5G.

The processor 660 may be a semiconductor integrated circuit including a central processing unit (CPU), for example. The ROM 670 is, for example, a writable memory (e.g., a PROM), a rewritable memory (e.g., a flash memory), or a read-only memory. The RAM 680 provides a work area for temporarily expanding the control program stored in the ROM 670 at boot. The detailed configuration of the processor 660, the ROM 670, and the RAM 680 is similar to the processor 161, the ROM 163, and the RAM 162, and the detailed description thereof will be omitted herein.

The storage device 650 functions primarily as a database storage. The storage device 650 may be, for example, a magnetic storage device or a semiconductor storage device. The storage device 650 may be a device independent of the management device 600. For example, the storage device 650 may be a storage device connected to the management device 600 via the network 80, such as a cloud storage.

The terminal device 400 includes an input device 420, a display device 430, a storage device 450, a processor 460, a ROM 470, a RAM 480, and a communication device 490. These elements are connected to each other so that the elements can communicate with each other via a bus. The input device 420 is a device that converts instructions from the user into data and inputs the data into the computer. The input device 420 may be, for example, a keyboard, a mouse, or a touch panel. The display device 430 may be, for example, a liquid crystal display or an organic EL display. The processor 460, the ROM 470, the RAM 480, the storage device 450, and the communication device 490 are as described above for the example hardware configuration of the harvester 100, the transport vehicle 200, and the management device 600, and the description thereof will be omitted.

Next, the harvesting operation, in which the crop in the field is harvested using the harvester 100 and the transport vehicle 200 will be described. A control system 10 that controls such harvesting operations may be realized by the controller 160 of the harvester 100 and the controller 260 of the transport vehicle 200. The agricultural management system 1 may function as the control system 10 that controls such harvesting operations.

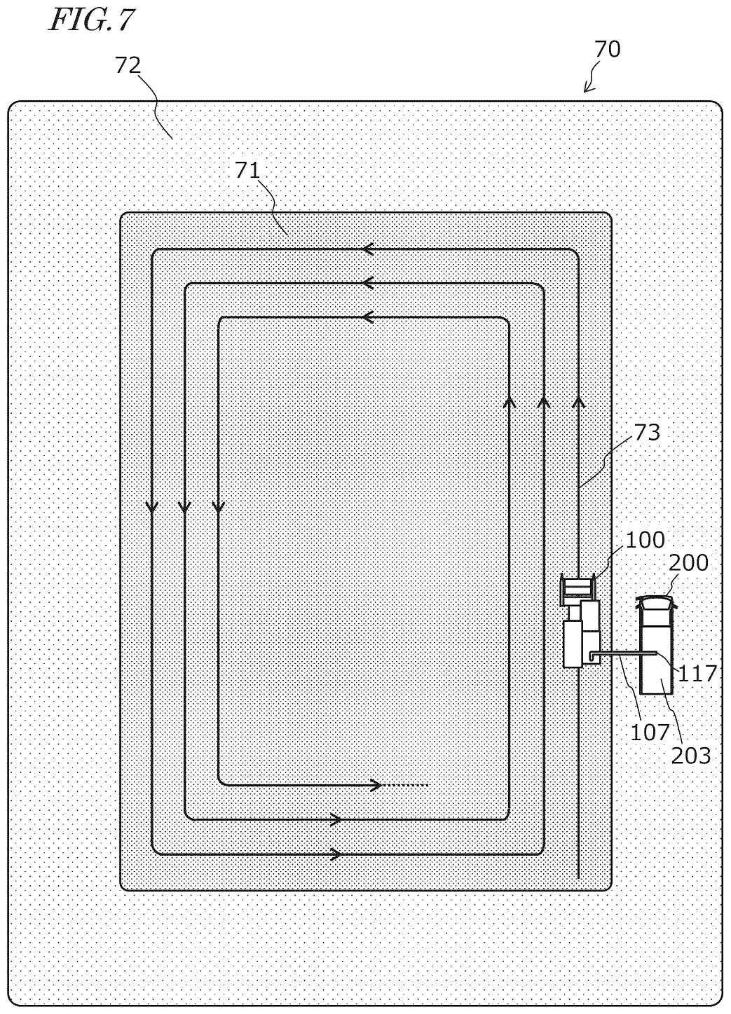

FIG. 7 shows the harvesting operation in which the harvester 100 and the transport vehicle 200 are used to harvest the crop in the field 70.

The harvester 100 of the present example embodiment harvests a crop while traveling through the field 70 by automated driving. In the field 70, the harvester 100 executes the operation of harvesting a crop while traveling along a pre-set target route 73. In the field 70, the positioning of the harvester 100 is performed mainly based on data output from the GNSS unit 120. In addition to the positioning data output from the GNSS unit 120, the position of the harvester 100 may be estimated based on data output from the LiDAR sensor 125 and/or the camera 126.

In the example shown in FIG. 7, the field 70 includes a work area 71 in which the harvester 100 harvests the crop and a headland 72 located around the outer edge of the field 70. Which areas of the field 70 correspond to the work area 71 and the headland 72 may be set in advance by the user. The harvester 100 automatically travels along the target route 73, as shown in FIG. 7, from the start point of work to the end point of work. Note that the target route 73 shown in FIG. 7 is merely an example, and the target route 73 can be determined in any way. The target route 73 may be created based on user operations or may be created automatically. For example, the target route 73 may be created so as to cover the entire work area 71 inside the field 70.

In the present example embodiment, the transport vehicle 200 is caused to travel alongside the harvester 100 that harvests a crop while traveling inside the field 70 by automated driving. The transport vehicle 200 receives the harvested crop discharged from the harvester 100 while traveling alongside the harvester 100 by automated driving, and stores the harvested crop in the load bed 203.

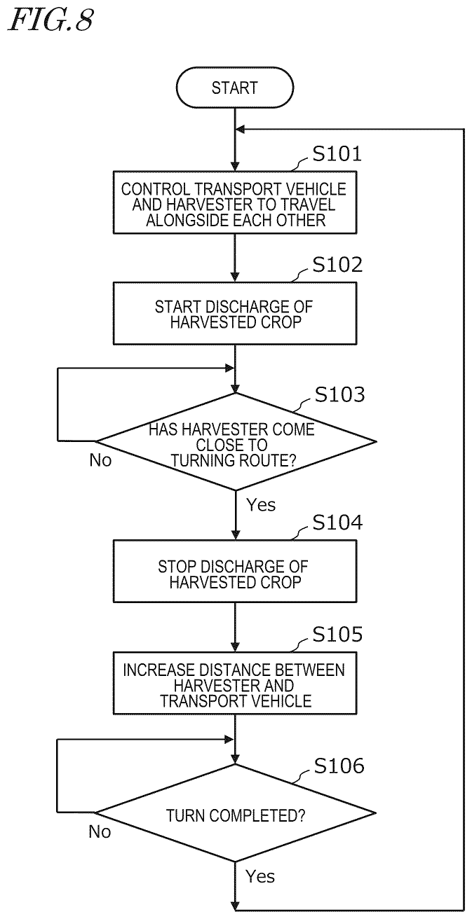

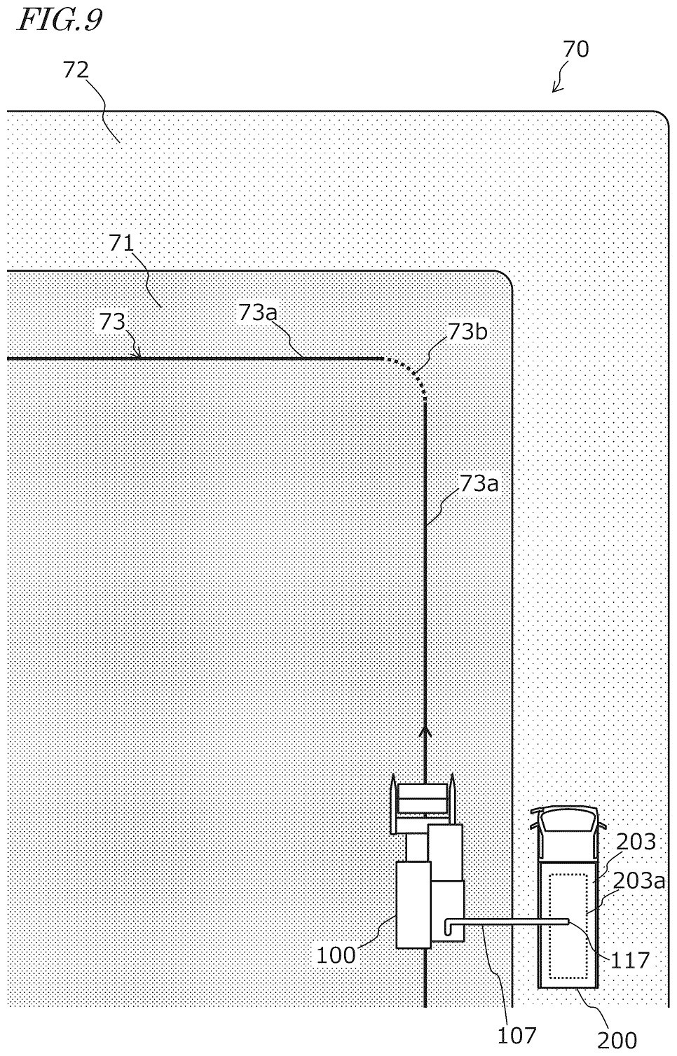

FIG. 8 is a flow chart showing an example control for the harvesting operation of harvesting the crop in field 70 using the harvester 100 and the transport vehicle 200. FIG. 9 is a diagram showing an example of the harvester 100 that automatically travels along the target route 73 within the field 70, and the transport vehicle 200 that travels alongside the harvester 100.

The harvester 100 harvests a crop while traveling along the target route 73 by automated driving. The processor 161 of the harvester 100 (FIG. 4) causes the ECU 165 to control the harvester 100 to travel along the target route 73 by automated driving, and causes the ECU 167 to control the crop harvesting operation. The ECU 165 controls the operation of the drive device 140 to cause the harvester 100 to travel by automated driving. The ECU 167 controls the operation of the power transmission device 141 to cause various devices that perform the crop harvesting operation to perform the desired operation. The cutting device 103 cuts the crop in the field 70. The threshing device 105 threshes the cut crop. The tank 106 stores the harvested crop obtained by threshing the grain, etc. The straw disposal device 108 finely cuts, and discharges to the outside, the stalk portion, etc., after the harvest, such as grain, has been removed. The discharge device 107 discharges the harvested crop in the tank 106 while the harvester 100 and the transport vehicle 200 are traveling alongside each other.

The processor 261 of the transport vehicle 200 (FIG. 5) causes the ECU 265 to control the transport vehicle 200 to travel alongside the harvester 100 (step S101 of FIG. 8).

The harvester 100 and the transport vehicle 200 exchange data with each other via the communication devices 190 and 290. The processor 161 of the harvester 100 transmits information on the geographic coordinates of the position of the harvester 100 acquired from the GNSS unit 120 and information on the direction of the harvester 100 to the transport vehicle 200 via the communication device 190.

The processor 261 of the transport vehicle 200 calculates the geographic coordinates of a position adjacent to the side of the harvester 100 based on information of the geographic coordinates and orientation of the harvester 100, and sets the position of the calculated geographic coordinates as the target position. In the examples shown in FIG. 7 and FIG. 9, the processor 261 calculates the geographic coordinates of a position adjacent to the right side of the harvester 100. Since the position of the traveling harvester 100 changes, the target position is updated as necessary.

The processor 261 causes the ECU 265 to control the transport vehicle 200 to travel so as to reach the latest target position. Thus, the transport vehicle 200 can travel alongside the harvester 100.

The discharge device 107 of the harvester 100 is rotatable, and in the example shown in FIG. 7 and FIG. 9, a discharge outlet 117 of the discharge device 107 is located on the right side of the harvester 100.

When the position of a discharge outlet 117 is within a first range 203a, in which the harvested crop discharged from the discharge outlet 117 can be received in the load bed 203, the discharged harvested crop can be stored in the load bed 203 by discharging the harvested crop from the discharge device 107.

The three-dimensional point cloud data output by the LiDAR sensor 225 of the transport vehicle 200 includes information on positions of a plurality of points and information (attribute information) such as the reception strength of the photo detector. The information on positions of a plurality of points is, for example, information on the direction of emission of the laser pulse corresponding to each point and the distance between the LiDAR sensor and each point. For example, the information on positions of a plurality of points is information on the coordinates of each point in the local coordinate system. The local coordinate system is a coordinate system that moves together with the transport vehicle 200, and is also referred to as the sensor coordinate system. The coordinates of each point can be calculated from the direction of emission of the laser pulse corresponding to the point and the distance between the LiDAR sensor and the point.

The processor 261 controls the sensor to sense the discharge outlet 117. For example, the discharge outlet 117 is sensed using the LiDAR sensor 225. The three-dimensional point cloud data output by the LiDAR sensor 225, for example, includes information on the coordinates of each of the plurality of points in their respective local coordinate systems.

The processor 261 identifies point cloud data representing the discharge outlet 117 from the three-dimensional point cloud data output by the LiDAR sensor 225, using an estimation model generated by machine learning, for example. The processor 261 acquires information on the coordinates of each of the plurality of points included in the point cloud data representing the discharge outlet 117. The estimation model is stored in advance in the storage device 264.

The coordinate values of each portion of a first range 203a in the load bed 203 in the local coordinate system are stored in advance in the storage device 264. The processor 261 can determine whether the position of the discharge outlet 117 is within the first range 203a by comparing the coordinate values of the discharge outlet 117 and the coordinate values of the first range 203a.

Note that the positional relationship between the discharge outlet 117 and the first range 203a may be determined using sensing data other than the sensing data of the LiDAR sensor 225. For example, whether the position of the discharge outlet 117 is within the first range 203a may be determined using sensing data output by the camera 226, which has captured the image of the discharge outlet 117 and the load bed 203.

If the position of the discharge outlet 117 is within the first range 203a, the processor 261 transmits, to the harvester 100 via the communication device 290, permission information indicating that the discharge of the harvested crop from the discharge device 107 is permitted.

Upon receiving the permission information, the processor 161 causes the ECU 167 to control the operation of discharging the harvested crop from the discharge device 107. The ECU 167 controls the operation of the power transmission device 141 so as to cause the discharge device 107 to discharge the harvested crop in the tank 106 (step S102). The harvested crop discharged from the discharge outlet 117 goes into the load bed 203 and is stored in the load bed 203.

When the position of the discharge outlet 117 is outside the first range 203a, the processor 261 transmits a stop instruction to stop the discharge of the harvested crop from the discharge device 107 to the harvester 100 via the communication device 190. Upon receiving the stop instruction, the processor 161 causes the ECU 167 to execute a control to stop the discharge of the harvested crop from the discharge device 107. When the position of the discharge outlet 117 is again within the first range 203a, the processor 261 transmits the permission information to the harvester 100, and the discharge of the harvested crop is resumed.

FIG. 10 is a diagram showing how the harvester 100 and the transport vehicle 200 shown in FIG. 9 having moved forward while traveling alongside each other.

As shown in FIG. 9 and FIG. 10, the target route 73 includes main routes 73a that include straight routes and a turning route 73b that connects together a main route 73a and another main route 73a. The main route 73a is a straight route, but the main route 73a may include a curved portion. The direction of travel of the harvester 100 is changed by passing through the turning route 73b.

The processor 161 determines whether the position of the harvester 100 traveling along the main route 73a has come close to the turning route 73b, based on the information of geographic coordinates acquired from the GNSS unit 120 and the information of geographic coordinates included in the information of the target route 73 (step S103). The processor 161 determines, for example, whether the distance between the front end of the harvester 100 and the start position of the turning route 73b is less than or equal to a predetermined distance. The predetermined distance is, for example, 1 to 5 m, but is not limited to that value. The information on the target route 73 includes information on the geographic coordinates of the start position and the end position of each turning route 73b. The positional relationship between the reference position of the harvester 100 and the front end and the rear end of the harvester 100 is stored in advance in the storage device 164. The reference position in the local coordinate system can be set to any position of the harvester 100. The reference position is, for example, the position at which the GNSS unit 220 is provided. The coordinate values of the reference position are stored in advance in the storage device 164. The processor 161 can calculate the geographic coordinates of the front end and the rear end of the harvester 100 from such a positional relationship and information on the geographic coordinates acquired from the GNSS unit 120.

If it is determined that the distance between the front end of the harvester 100 and the start position of the turning route 73b is greater than a predetermined distance, the processor 161 continues the control to discharge the harvested crop from the discharge device 107. If it is determined that the distance between the front end of the harvester 100 and the start position of the turning route 73b is less than or equal to a predetermined distance, the processor 161 causes the ECU 167 to execute a control to stop the discharge of the harvested crop from the discharge device 107. Thus, the discharge of the harvested crop from the discharge device 107 is stopped (step S104).

The processor 161 transmits stop information, which indicates that the discharge of the harvested crop from the discharge device 107 has been stopped, to the transport vehicle 200 via the communication device 190. In parallel, the processor 161 transmits, to the transport vehicle 200 via the communication device 190, course-of-travel information indicating that the harvester 100 is now entering g route 73b. Upon receiving the stop information and the course-of-travel information, the processor 261 causes the ECU 265 to execute a control to cause the transport vehicle 200 to move away from the harvester 100 (step S105).

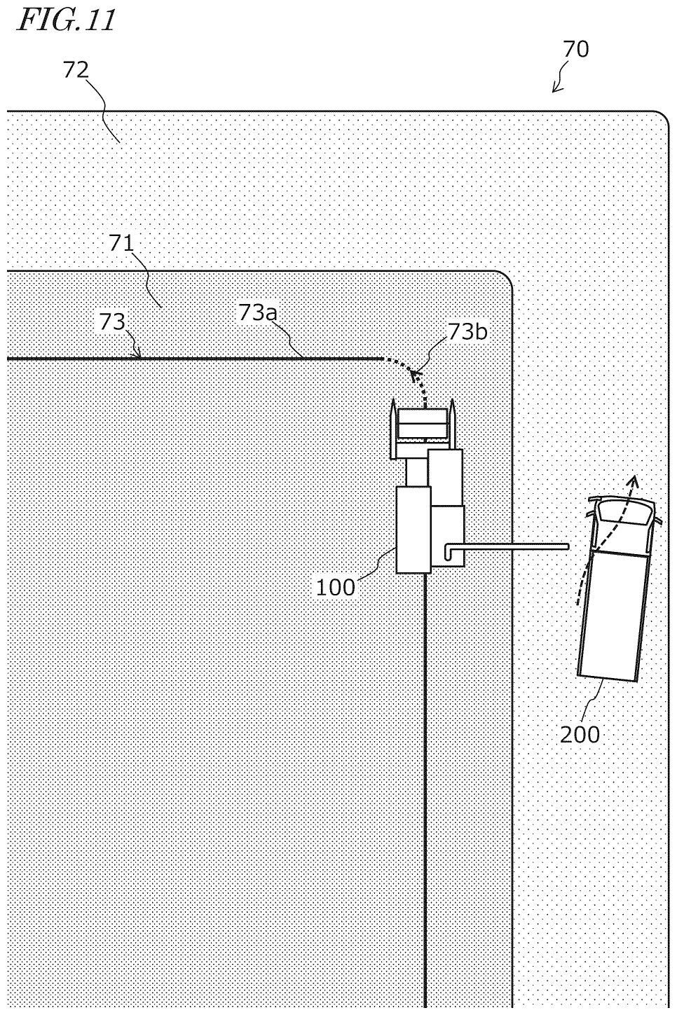

FIG. 11 is a diagram showing how the transport vehicle 200, having traveled alongside the harvester 100, moves away from the harvester 100. The transport vehicle 200, having been traveling alongside the right side of the harvester 100, can move away from the harvester 100 by taking a course of travel going away to the right of the harvester 100 and/or by making the traveling speed of the transport vehicle 200 different from that of the harvester 100.

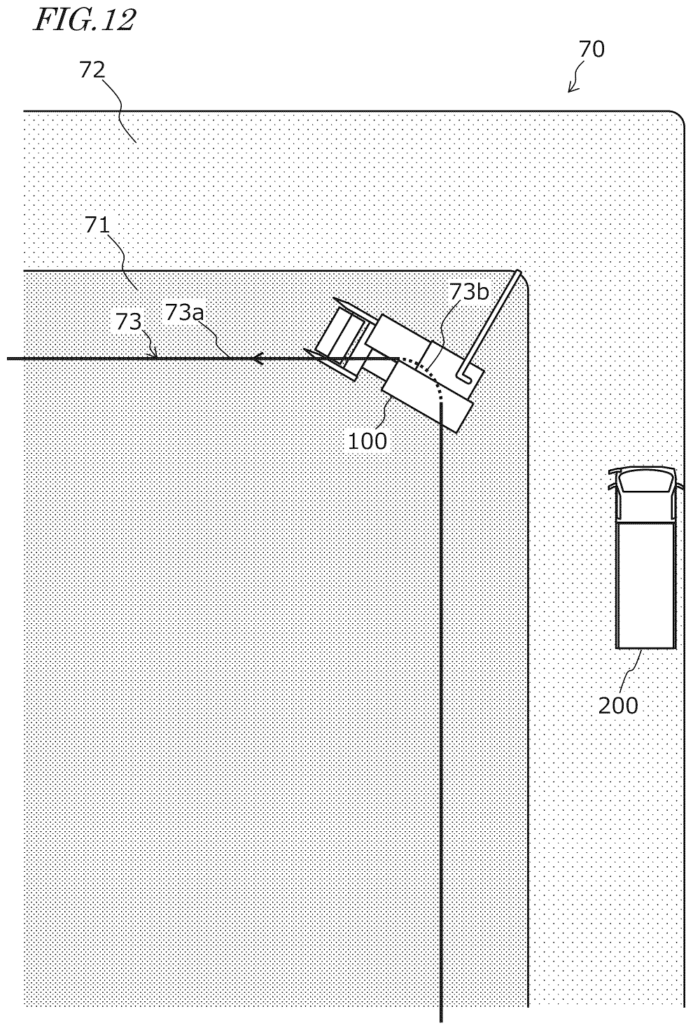

FIG. 12 is a diagram showing the harvester 100 turning along the turning route 73b. The processor 161 causes the ECU 167 to execute a control to stop harvesting the crop during the turn. The processor 261 of the transport vehicle 200 performs a control to increase the distance between the harvester 100 and the transport vehicle 200 while the harvester 100 makes a turn, compared to when the harvester 100 is traveling while harvesting the crop.

As described with referring to FIG. 9 and FIG. 10, the harvester 100 and the transport vehicle 200 travel alongside each other while maintaining a positional relationship such that the transport vehicle 200 can receive the harvested crop discharged from the harvester 100. By having the harvester 100, which harvests the crop, and the transport vehicle 200, which receives and stores the harvested crop discharged from the harvester 100, travel alongside each other, it is possible to efficiently harvest the crop in the field 70.

On the other hand, the control to turn the harvester 100 and the transport vehicle 200 while maintaining such a positional relationship becomes complicated. In the present example embodiment, by increasing the distance between the harvester 100 and the transport vehicle 200 while the harvester 100 is making a turn, it is possible to prevent the presence of the transport vehicle 200 from interfering with the smooth turning of the harvester 100. Even when the harvester 100 makes a complicated turn involving backing up, for example, the harvester 100 can make the turn smoothly.

By increasing the distance between the harvester 100 and the transport vehicle 200 while the harvester 100 is making a turn, it is possible to prevent the presence of the harvester 100 from interfering with the smooth turning of the transport vehicle 200.

By stopping the discharge of the harvested crop while the harvester 100 is making a turn, it is possible to allow the harvester 100 to turn smoothly. By increasing the distance between the harvester 100 and the transport vehicle 200 after the harvester 100 has stopped discharging the harvested crop, it is possible to prevent the harvested crop from being discharged to anything other than the transport vehicle 200.

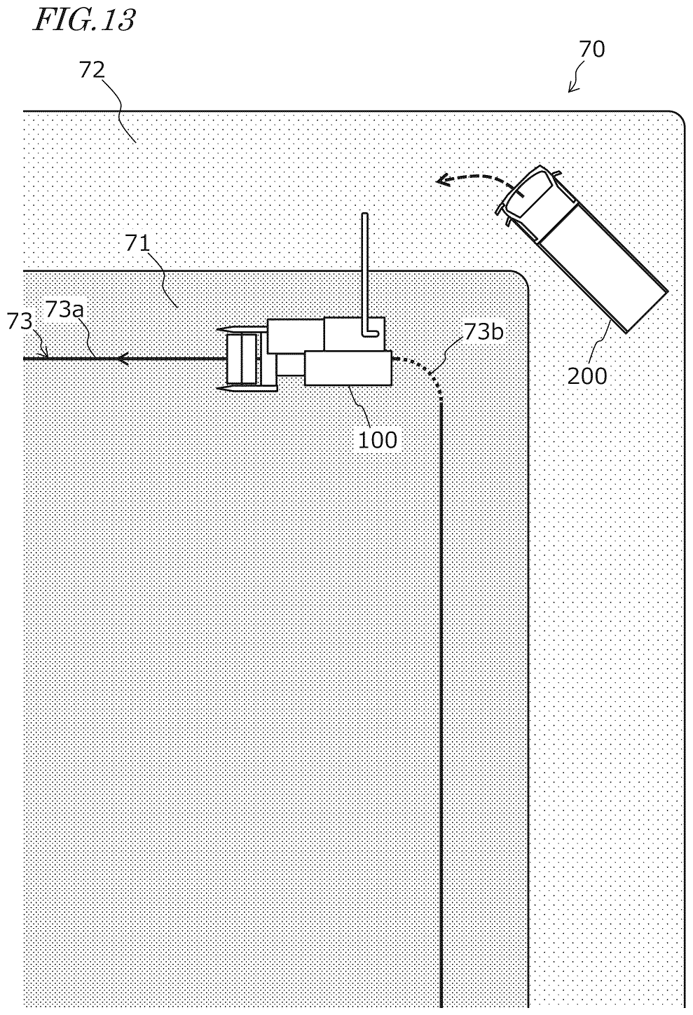

FIG. 13 is a diagram showing the harvester 100 having turned and traveling along the next main route 73a. The processor 161 calculates the geographic coordinates of the rear end of the harvester 100 based on the positional relationship between the reference position and the rear end of the harvester 100 and information of the geographic coordinates acquired from the GNSS unit 120. The processor 161 determines whether the rear end of the harvester 100 has gone past end position of the turning route 73b and is located along the next main route 73a (step S106).

If it is determined that the rear end of the harvester 100 has gone past the end position of the turning route 73b and is located along the next main route 73a, the processor 161 executes a control to cause the ECU 167 to resume the crop harvesting operation. The ECU 167 controls the operation of the power transmission mechanism 141 to cause various devices that perform the crop harvesting operation to perform the desired operation. In parallel, the processor 161 transmits, to the transport vehicle 200 via the communication device 190, course-of-travel information indicating that the turn has been complete. Upon receiving the course-of-travel information, the processor 261 causes the ECU 265 to control the transport vehicle 200 to travel alongside the harvester 100 (step S101).

The processor 261 of the transport vehicle 200 calculates the geographic coordinates of a position adjacent to the side of the harvester 100 based on information of the geographic coordinates and orientation of the harvester 100, and sets the position of the calculated geographic coordinates as the target position. The processor 261 causes the ECU 265 to control the transport vehicle 200 to travel to the target position.

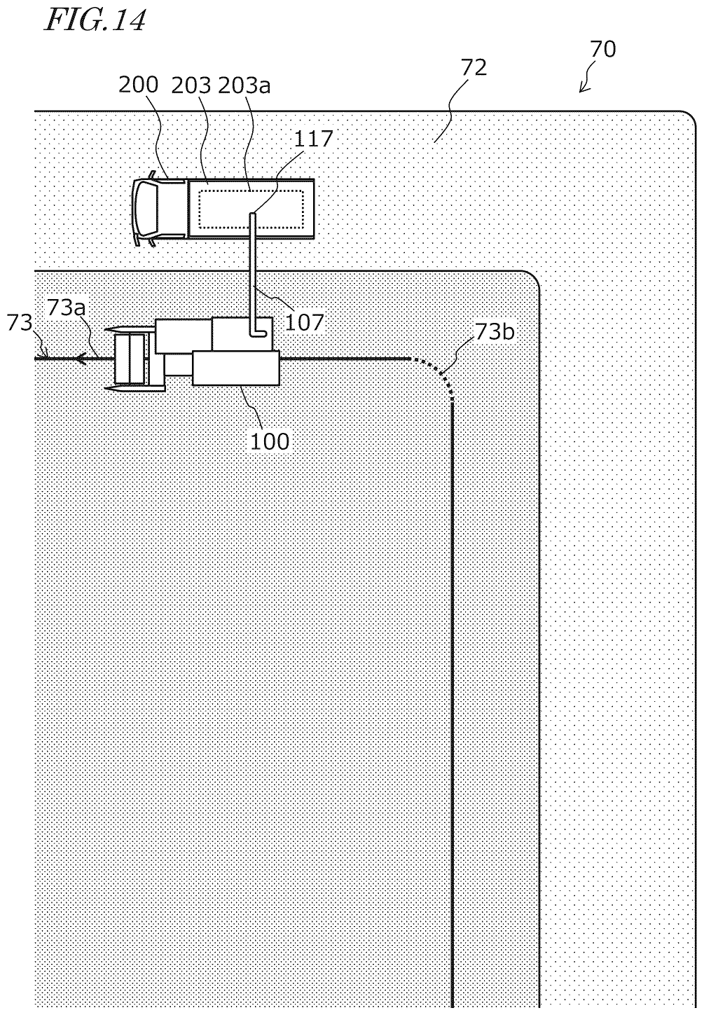

FIG. 14 is a diagram showing the transport vehicle 200 having reached the position (target position) for traveling alongside the harvester 100. By moving the transport vehicle 200 to a position where the transport vehicle 200 can receive the harvested crop discharged from the harvester 100, it is possible to resume the transfer of the harvested crop from the harvester 100 to the transport vehicle 200.

The harvester 100 and the transport vehicle 200 repeat the operations of steps S101 to S106. This allows the harvesting operation to be performed by the harvester 100, which harvests a crop while traveling in the field 70 by automated driving, and the transport vehicle 200, which receives and stores the harvested crop discharged from the harvester 100 while traveling alongside the harvester 100 by automated driving. In order to end the harvesting operation in the field 70, the control shown in FIG. 8 is ended.

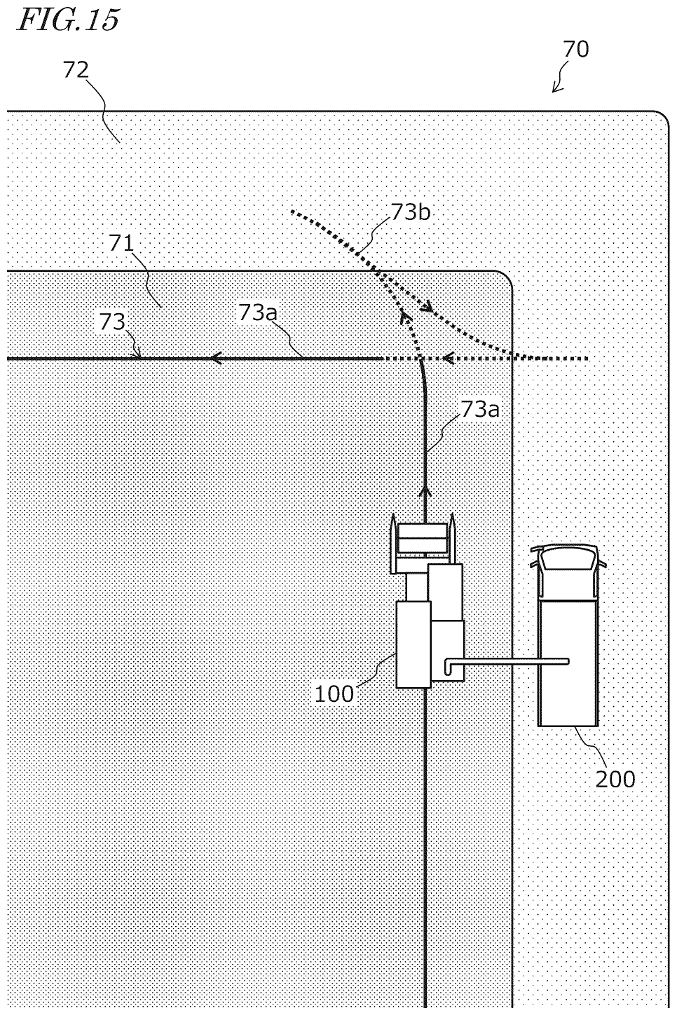

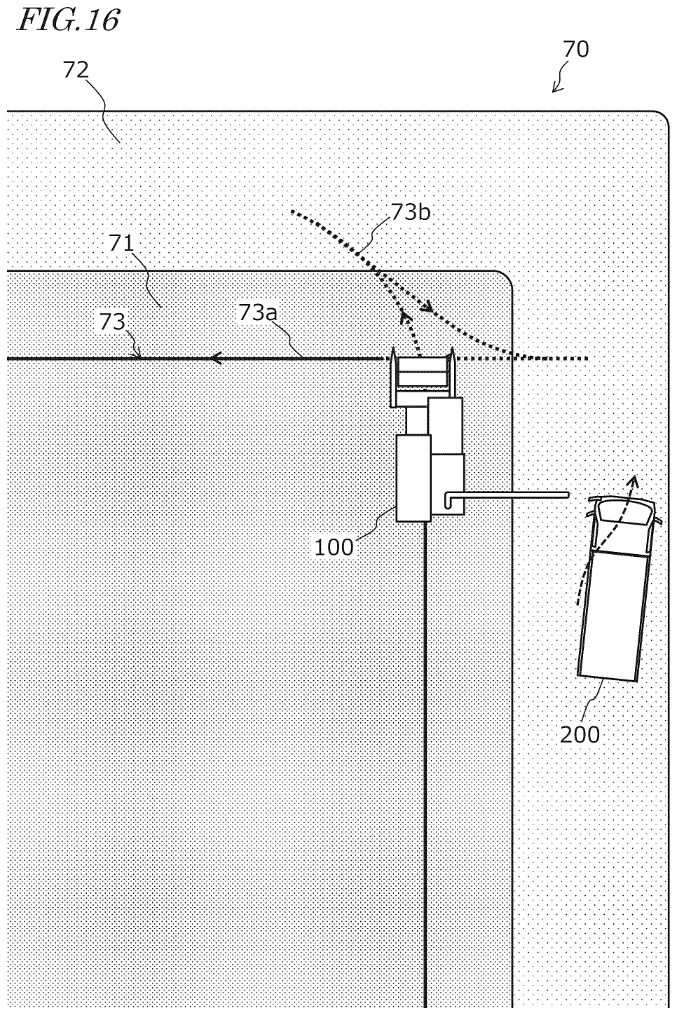

FIG. 15 shows an example of the complicated turning route 73b involving backing up. In step S103, if it is determined that the distance between the front end of the harvester 100 and the start position of the turning route 73b is less than or equal to a predetermined distance, the processor 161 causes the ECU 167 to execute a control to stop the discharge of the harvested crop from the discharge device 107. Thus, the discharge of the harvested crop from the discharge device 107 is stopped (step S104). Upon receiving the stop information and the course-of-travel information, the processor 261 causes the ECU 265 to execute a control to cause the transport vehicle 200 to move away from the harvester 100 (step S105). FIG. 16 is a diagram showing how the transport vehicle 200, which has traveled alongside the harvester 100, moves away from the harvester 100.

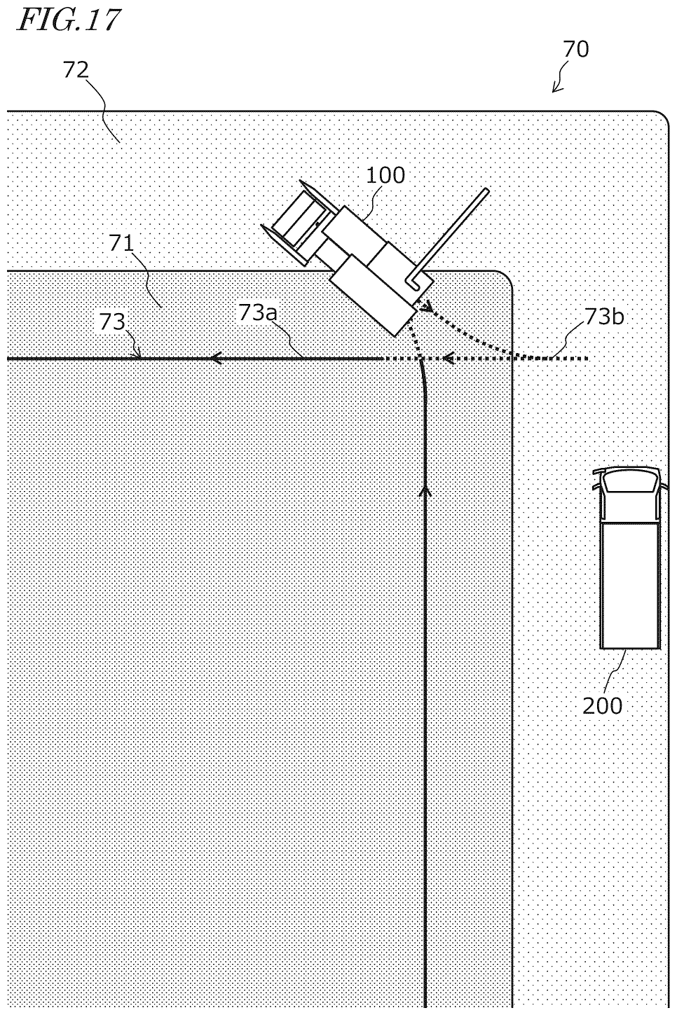

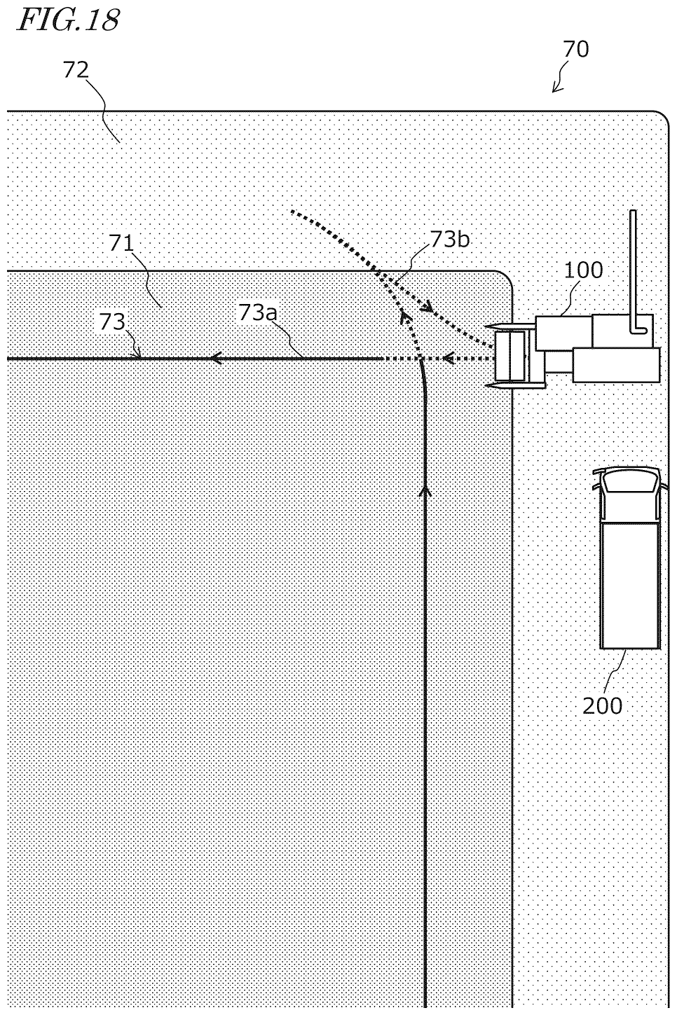

FIG. 17 and FIG. 18 show the harvester 100 turning along the turning route 73b. Along the turning route 73b of this example, the harvester 100 changes its direction of travel by moving forward while turning left and then moving backward while turning right. The processor 161 causes the ECU 167 to execute a control to stop harvesting the crop during the turn. The processor 261 of the transport vehicle 200 performs a control to increase the distance between the harvester 100 and the transport vehicle 200 while the harvester 100 makes a turn, compared to when the harvester 100 is traveling while harvesting the crop. By increasing the distance between the harvester 100 and the transport vehicle 200 while the harvester 100 makes a turn, the harvester 100 can smoothly make a turn even when the harvester 100 is making a complicated turn involving backing up.

Next, an example of the operation of having the transport vehicle 200 wait at a predetermined position while the harvested crop accumulated in the tank 106 of the harvester 100 is less than a first predetermined amount will be described.

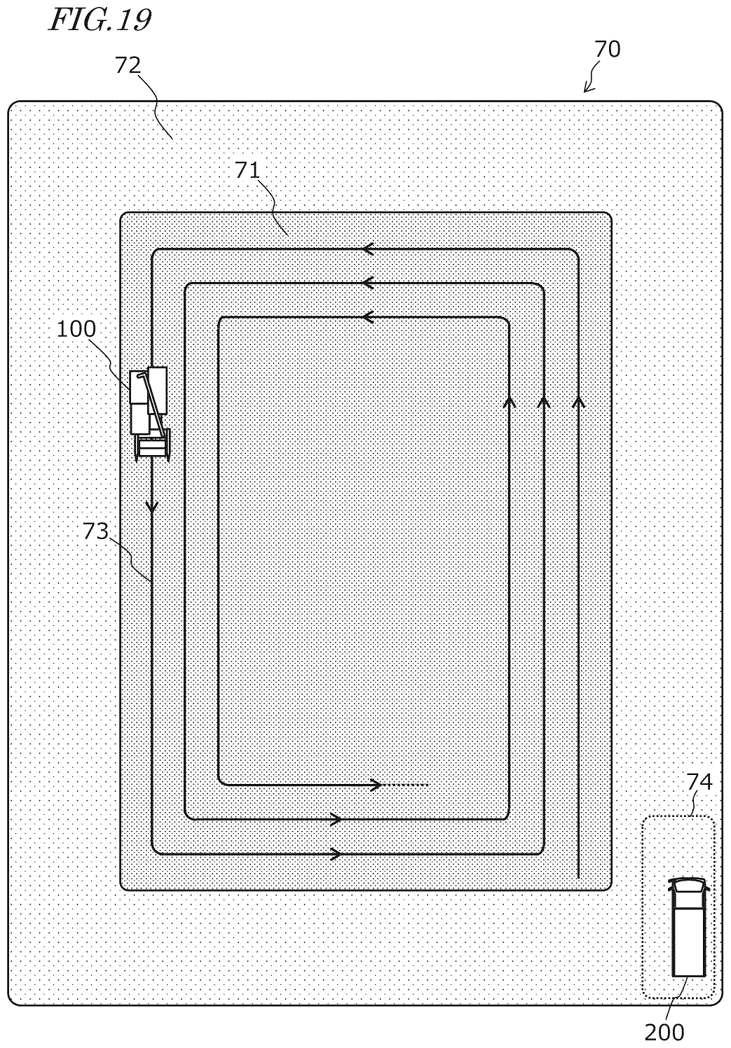

FIG. 19 is a diagram showing the transport vehicle 200 waiting at a predetermined position 74 in the field 70. The predetermined position 74 can be set at any position that does not interfere with the harvesting operation by the harvester 100. The predetermined position 74 may be set to a position where the harvesting operation in the work area 71 has already been completed, as long as it does not interfere with the harvesting operation by the harvester 100. The predetermined position 74 may also be set to a position outside the field 70.

When the harvester 100 is harvesting a crop, the processor 161 determines whether the harvested crop accumulated in the tank 106 is equal to or greater than the first predetermined amount. For example, the processor 161 determines whether the weight value of the harvested crop in the tank 106 detected by the load sensor 156 is equal to or greater than a first predetermined weight. The first predetermined weight is, for example, 50 to 90% of the maximum weight of the harvested crop that can be stored in the tank 106, but is not limited to that value.

While the harvested crop accumulated in the tank 106 is less than the first predetermined weight, the processor 161 does not transmit a parallel run instruction to cause the transport vehicle 200 to travel alongside the harvester 100. The processor 261 performs a control to cause the transport vehicle 200 to wait at the predetermined position 74 while the processor 261 has not received the parallel run instruction.

If it is determined that the harvested crop accumulated in the tank 106 has become equal to or greater than the first predetermined weight, the processor 161 transmits, to the transport vehicle 200 via the communication device 190, the parallel run instruction to cause the transport vehicle 200 to travel alongside the harvester 100. Upon receiving the parallel run instruction, the processor 261 performs a control to move the transport vehicle 200 to a position where the transport vehicle 200 can receive the harvested crop discharged from the harvester 100. The control of moving the transport vehicle 200 to a position where the transport vehicle 200 can receive the harvested crop discharged from the harvester 100 is as described above using FIG. 8.

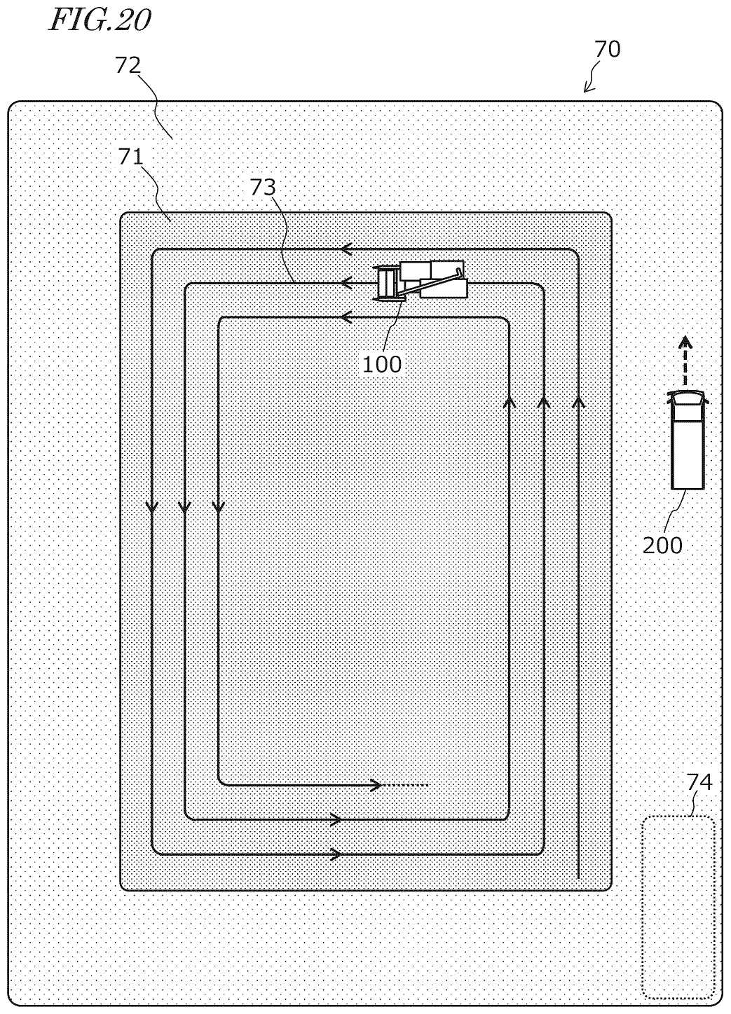

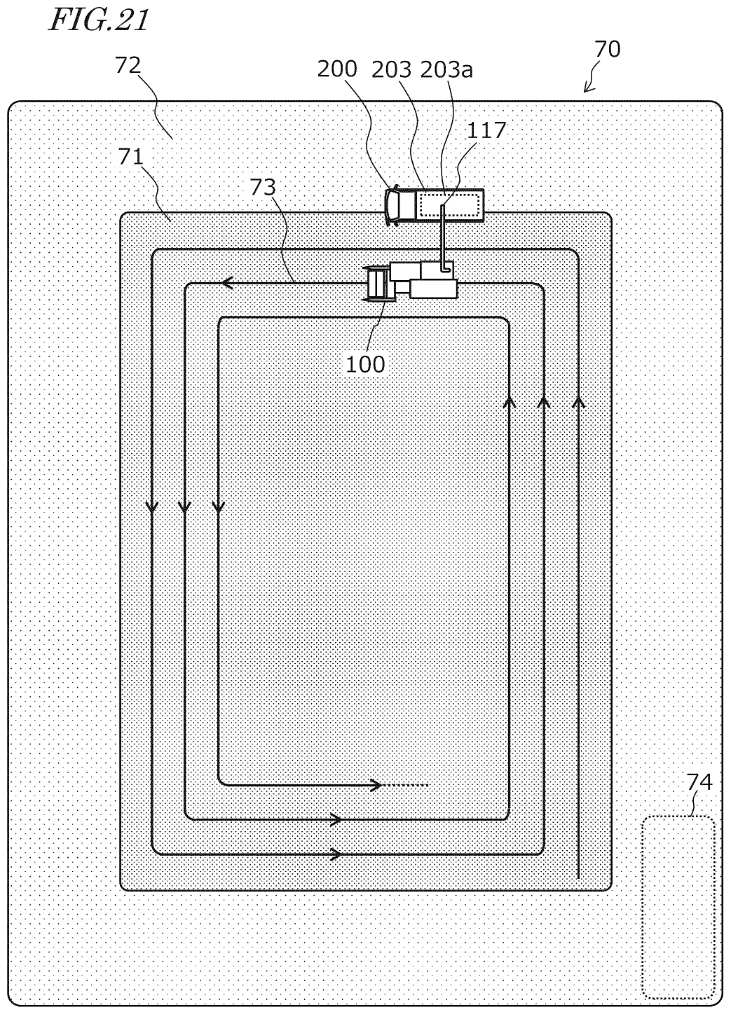

FIG. 20 is a diagram showing the transport vehicle 200 moving toward a position (target position) where the transport vehicle 200 can receive the harvested crop discharged from the harvester 100. FIG. 21 is a diagram showing the transport vehicle 200 having reached the position where the transport vehicle 200 can receive the harvested crop discharged from the harvester 100. When the position of the discharge outlet 117 is within the first range 203a, the processor 261 transmits, to the harvester 100 via the communication device 290, permission information indicating that the discharge of the harvested crop from the discharge device 107 is permitted.

Upon receiving the permission information, the processor 161 causes the ECU 167 to execute a control for the operation of discharging the harvested crop from the discharge device 107. The harvested crop discharged from the discharge outlet 117 enters the load bed 203 and is stored in the load bed 203. As the harvester 100 and the transport vehicle 200 execute the operation described above using FIG. 8, the harvesting operation can be performed by the harvester 100, which harvests a crop while traveling in the field 70 by automated driving, and the transport vehicle 200, which receives and stores the harvested crop discharged from the harvester 100 while traveling alongside the harvester 100 by automated driving.

As the harvested crop is transferred from the harvester 100 to the transport vehicle 200 when the harvested crop accumulated in the harvester 100 has become equal to or greater than the first predetermined amount, it is possible to shorten the amount of time for executing a control to cause the harvester 100 and the transport vehicle 200 to travel alongside each other.

Next, an example of the operation of moving the transport vehicle 200 to a building used to store the harvested crop when the harvested crop has accumulated to a second predetermined amount or more in the load bed 203 of the transport vehicle 200, will be described.

While the transport vehicle 200 is receiving the harvested crop discharged from the harvester 100, the processor 261 determines whether the amount of the harvested crop accumulated in the load bed 203 is equal to or greater than the second predetermined amount. For example, the processor 261 determines whether the weight value of the harvest stored in the load bed 203 detected by the load sensor 256 is equal to or greater than the second predetermined weight. The second predetermined weight is, for example, 80 to 100% of the maximum weight of the harvested crop that can be stored in the load bed 203, but is not limited to that value.

While the harvested crop accumulated in the load bed 203 is less than the second predetermined weight, the processor 261 continues to control the operation in which the transport vehicle 200 receives the harvested crop discharged from the harvester 100. If it is determined that the harvested crop accumulated in the load bed 203 has become equal to or greater than the second predetermined weight, the processor 261 transmits, to the harvester 100 via the communication device 190, a stop instruction to stop the discharge of the harvested crop from the discharge device 107. Upon receiving receives the stop instruction, the processor 161 causes the ECU 167 to execute a control to stop the discharge of the harvested crop from the discharge device 107.

If it is determined that the harvested crop accumulated in the load bed 203 has become equal to or greater than the second predetermined weight, the processor 261 performs a control to move the transport vehicle 200 to the building to store the harvested crop.

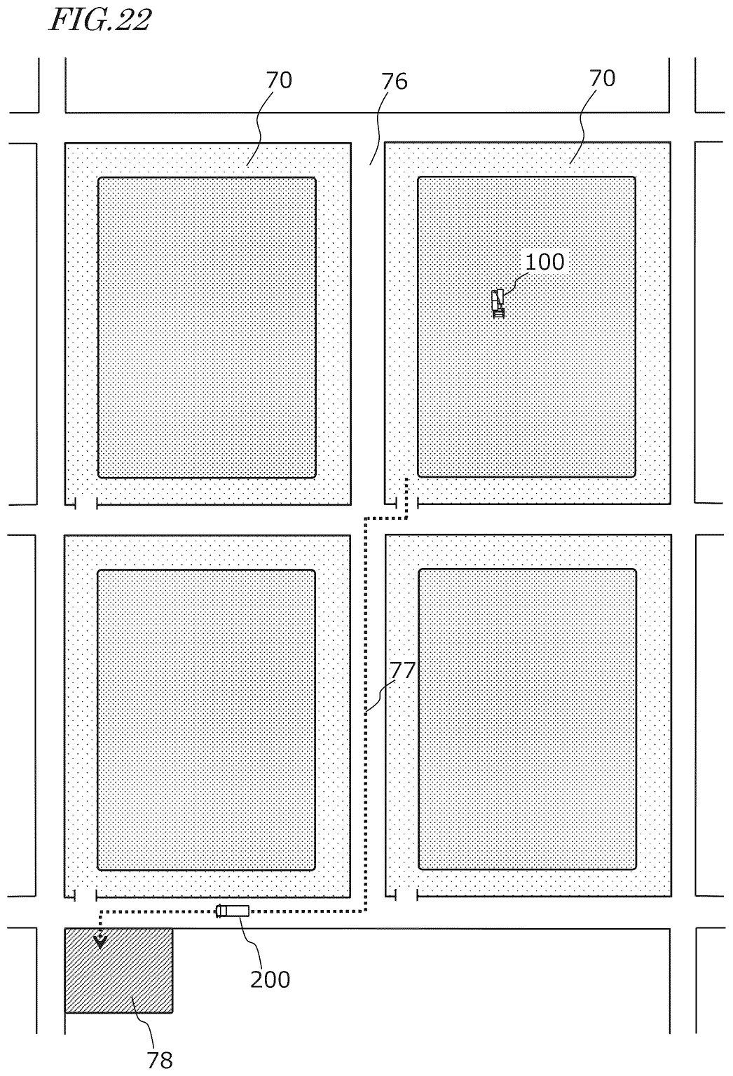

FIG. 22 is a diagram showing the transport vehicle 200 moving to the storage shed 78 to store the harvested crop. A target route 77 to move from the field 70 to the storage shed 78 is set in advance. The target route 77 is, for example, stored in advance in the storage device 264 of the transport vehicle 200. The processor 261 causes the ECU 265 to control the transport vehicle 200 to automatically travel along the target route 77.

When the transport vehicle 200 arrives at the storage shed 78, the harvested crop in the load bed 203 is transferred to the storage shed 78. The transport vehicle 200, with its load bed 203 empty, may return to the field 70 along the same route as the target route 77.

While the transport vehicle 200 is a truck in the above description of the example embodiment, the transport vehicle 200 is not limited thereto, and may be a tractor to which a load bed is connected, for example.

The control system 10 of the present example embodiment can be retrofitted to agricultural machines that do not have those functions. Such systems can be manufactured and sold independently of agricultural machines. Computer programs used in such systems can also be manufactured and sold independently of agricultural machines. Computer programs can be provided, for example, stored in a computer-readable non-transitory storage medium. Computer programs can also be provided as downloads via an electrical telecommunication line (e.g., the Internet).

Some or all of the processes executed by the processors 161 and 261 in the control system 10 may be executed by other devices. Such other devices may be the processor 660 of the management device 600, the processor 460 of the terminal device 400, and at least one of the operation terminals 131. In such a case, the processors of such other devices may be included in the controller of the control system 10.

As described above, the present disclosure includes control systems, control methods, and transport vehicles set forth below.
[Item 1]

A control system 10 for controlling a harvesting operation performed by a harvester 100, which harvests a crop while traveling in a field 70 by automated driving, and a transport vehicle 200, which receives a harvested crop discharged from the harvester 100 while traveling alongside the harvester 100 by automated driving, the control system including a first controller 160 configured or programmed to control an operation of discharging the harvested crop of the harvester 100, and a second controller 260 configured or programmed to control an operation of the transport vehicle 200 so that the transport vehicle 200 travels by automated driving, wherein the second controller 260 is configured or programmed to perform a control to increase a distance between the harvester 100 and the transport vehicle 200 while the harvester 100 makes a turn, compared to when the harvester 100 is traveling while harvesting the crop.

The harvester 100 and the transport vehicle 200 travel alongside each other while maintaining a positional relationship such that the transport vehicle 200 can receive the harvested crop discharged from the harvester 100. By having the harvester 100, which harvests the crop, and the transport vehicle 200, which receives and stores the harvested crop discharged from the harvester 100, travel alongside each other, it is possible to efficiently harvest the crop in the field 70. On the other hand, a control to turn the harvester 100 and the transport vehicle 200 while maintaining such a positional relationship will be complicated.

By increasing the distance between the harvester 100 and the transport vehicle 200 while the harvester 100 is making a turn, it is possible to prevent the presence of the transport vehicle 200 from interfering with the smooth turning of the harvester 100. Even when the harvester 100 makes a complicated turn involving backing up, for example, the harvester 100 can make the turn smoothly.

By increasing the distance between the harvester 100 and the transport vehicle 200 while the harvester 100 is making a turn, it is possible to prevent the presence of the harvester 100 from interfering with the smooth turning of the transport vehicle 200.
[Item 2]

The control system 10 according to item 1, wherein the first controller 160 is configured or programmed to perform a control to stop the discharge of the harvested crop from the harvester 100 while the harvester 100 is making a turn, and the second controller 260 is configured or programmed to perform a control to increase the distance between the harvester 100 and the transport vehicle 200 after the first controller 160 performs a control to stop the discharge of the harvested crop from the harvester 100.

By stopping the discharge of the harvested crop while the harvester 100 is making a turn, it is possible to allow the harvester 100 to turn smoothly. By increasing the distance between the harvester 100 and the transport vehicle 200 after the harvester 100 has stopped discharging the harvested crop, it is possible to prevent the harvested crop from being discharged to anything other than the transport vehicle 200.
[Item 3]

The control system 10 according to item 1 or 2, wherein when the harvester 100 completes the turn, the second controller 260 configured or programmed to perform a control to move the transport vehicle 200 to a position where the transport vehicle 200 can receive the harvested crop discharged from the harvester 100.

It is possible to resume the transfer of the harvested crop from the harvester 100 to the transport vehicle 200.
[Item 4]

The control system 10 according to any one of items 1 to 3, wherein when the harvested crop accumulated in the harvester 100 is less than a first predetermined amount, the second controller 260 is configured or programmed to perform a control to cause the transport vehicle 200 to wait at a predetermined position, and when the harvested crop accumulated in the harvester 100 has become equal to or greater than the first predetermined amount, the second controller 260 is configured or programmed to perform a control to move the transport vehicle 200 to a position where the transport vehicle 200 can receive the harvested crop discharged from the harvester 100.

When the harvested crop accumulated in the harvester 100 has become equal to or greater than the predetermined amount, the harvested crop can be transferred from the harvester 100 to the transport vehicle 200.
[Item 5]

The control system 10 according to any one of items 1 to 4, wherein when the harvested crop accumulated in the transport vehicle 200 has become equal to or greater than the second predetermined amount, the first controller 160 is configured or programmed to perform a control to stop the discharge of the harvested crop from the harvester 100, and the second controller 260 is configured or programmed to perform a control to move the transport vehicle 200 to a building to store the harvested crop.

When the harvested crop accumulated in the transport vehicle 200 has become equal to or greater than the predetermined amount, the harvested crop can be transferred from the transport vehicle 200 to a building such as a shed.
[Item 6]

The control system 10 according to any one of items 1 to 5, further including a sensor 125, 225 to sense at least one of the harvester 100 and the transport vehicle 200 to output sensor data, wherein when the harvester 100 discharges the harvested crop to the transport vehicle 200, the second controller 260 is configured or programmed to control, based on the sensor data, travel of the transport vehicle 200 to maintain a positional relationship between the transport vehicle 200 and the harvester 100 such that the transport vehicle 200 can receive the harvested crop discharged from the harvester 100.

By using sensor data, it is possible to perform high-precision position control.
[Item 7]

A transport vehicle 200 for transporting harvested crop that is harvested in a field 70, the transport vehicle 200 including a container 203 to receive and store the harvested crop discharged from a harvester 100 that harvests a crop in the field 70, and a controller 260 configured or programmed to control an operation of the transport vehicle 200 so that the transport vehicle 200 travels by automated driving, perform a control to cause the transport vehicle 200 to travel alongside the harvester 100 when the harvester 100 is traveling while harvesting the crop and discharging the harvested crop, and perform a control to increase a distance between the harvester 100 and the transport vehicle 200 when the harvester 100 is making a turn, compared to when the harvester 100 is traveling while harvesting the crop.

By increasing the distance between the harvester 100 and the transport vehicle 200 while the harvester 100 is making a turn, it is possible to prevent the presence of the transport vehicle 200 from interfering with the smooth turning of the harvester 100. Even when the harvester 100 makes a complicated turn involving backing up, for example, the harvester 100 can make the turn smoothly.

By increasing the distance between the harvester 100 and the transport vehicle 200 while the harvester 100 is making a turn, it is possible to prevent the presence of the harvester 100 from interfering with the smooth turning of the transport vehicle 200.
[Item 8]

The transport vehicle 200 according to item 7, wherein the harvester 100 stops the discharge of the harvested crop while the harvester 100 is making a turn, and the controller 260 is configured or programmed to perform a control to increase the distance between the harvester 100 and the transport vehicle 200 after the harvester 100 stops the discharge of the harvested crop.

By increasing the distance between the harvester 100 and the transport vehicle 200 after the harvester 100 has stopped discharging the harvested crop, it is possible to prevent the harvested crop from being discharged to anything other than the transport vehicle 200.
[Item 9]

The transport vehicle 200 according to item 7 or 8, wherein when the harvester 100 completes the turn, the controller 260 is configured or programmed to perform a control to move the transport vehicle 200 to a position where the transport vehicle 200 can receive the harvested crop discharged from the harvester 100.

It is possible to resume the transfer of the harvested crop from the harvester 100 to the transport vehicle 200.
[Item 10]

The transport vehicle 200 according to any one of items 7 to 9, wherein when the harvested crop accumulated in the harvester 100 is less than a first predetermined amount, the controller 260 is configured or programmed to perform a control to cause the transport vehicle 200 to wait at a predetermined position, and when the harvested crop accumulated in the harvester 100 has become equal to or greater than the first predetermined amount, the controller 260 is configured or programmed to perform a control to move the transport vehicle 200 to a position where the transport vehicle 200 can receive the harvested crop discharged from the harvester 100.

When the harvested crop accumulated in the harvester 100 has become equal to or greater than the predetermined amount, the harvested crop can be transferred from the harvester 100 to the transport vehicle 200.
[Item 11]

The transport vehicle 200 according to any one of items 7 to 10, wherein when the harvested crop accumulated in the container has become equal to or greater than the second predetermined amount, the controller 260 is configured or programmed to perform a control to move the transport vehicle 200 to a building to store the harvested crop.

When the harvested crop accumulated in the transport vehicle 200 has become equal to or greater than the predetermined amount, the harvested crop can be transferred from the transport vehicle 200 to a building such as a shed.
[Item 12]

The transport vehicle 200 according to any one of items 7 to 11, further including a sensor to sense the harvester 100 to output sensor data, wherein when the harvester 100 discharges the harvested crop to the transport vehicle 200, the controller 260 is configured or programmed to control, based on the sensor data, travel of the transport vehicle 200 to maintain a positional relationship between the transport vehicle 200 and the harvester 100 such that the transport vehicle 200 can receive the harvested crop discharged from the harvester 100.

By using sensor data, it is possible to perform high-precision position control.
[Item 13]

A control method for controlling a harvesting operation performed by a harvester 100, which harvests a crop while traveling in a field 70 by automated driving, and a transport vehicle 200, which receives a harvested crop discharged from the harvester 100 while traveling alongside the harvester 100 by automated driving, the control method including controlling an operation of discharging the harvested crop of the harvester 100, and performing a control to increase a distance between the harvester 100 and the transport vehicle 200 while the harvester 100 makes a turn, compared to when the harvester 100 is traveling while harvesting the crop.

By increasing the distance between the harvester 100 and the transport vehicle 200 while the harvester 100 is making a turn, it is possible to prevent the presence of the transport vehicle 200 from interfering with the smooth turning of the harvester 100. Even when the harvester 100 makes a complicated turn involving backing up, for example, the harvester 100 can make the turn smoothly.

By increasing the distance between the harvester 100 and the transport vehicle 200 while the harvester 100 is making a turn, it is possible to prevent the presence of the harvester 100 from interfering with the smooth turning of the transport vehicle 200.
[Item 14]

A control method for controlling a transport vehicle 200 that travels by automated driving and transports a harvested crop that is harvested in a field 70, wherein the transport vehicle 200 includes a container to receive and store the harvested crop discharged from a harvester 100 that harvests the crop in the field 70, the control method including performing a control to cause the transport vehicle 200 to travel alongside the harvester 100 when the harvester 100 is traveling while harvesting the crop and discharging the harvested crop, and performing a control to increase a distance between the harvester 100 and the transport vehicle 200 when the harvester 100 is making a turn, compared to when the harvester 100 is traveling while harvesting the crop.

By increasing the distance between the harvester 100 and the transport vehicle 200 while the harvester 100 is making a turn, it is possible to prevent the presence of the transport vehicle 200 from interfering with the smooth turning of the harvester 100. Even when the harvester 100 makes a complicated turn involving backing up, for example, the harvester 100 can make the turn smoothly.

By increasing the distance between the harvester 100 and the transport vehicle 200 while the harvester 100 is making a turn, it is possible to prevent the presence of the harvester 100 from interfering with the smooth turning of the transport vehicle 200.

The example embodiments and technologies of the present disclosure are particularly useful in the field of agricultural machines.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A control system for controlling a harvesting operation performed by an agricultural machine, which harvests a crop while traveling in a field by automated driving, and a transport vehicle, which receives a harvested crop discharged from the agricultural machine while traveling alongside the agricultural machine by automated driving, the control system comprising:
a first controller configured or programmed to perform an operation of discharging the harvested crop of the agricultural machine; and
a second controller configured or programmed to perform an operation of the transport vehicle so that the transport vehicle travels by automated driving; wherein
the second controller is configured or programmed to perform a control to increase a distance between the agricultural machine and the transport vehicle while the agricultural machine makes a turn, compared to when the agricultural machine is traveling while harvesting the crop.

2. The control system according to claim 1, wherein
the first controller is configured or programmed to perform a control to stop the discharge of the harvested crop from the agricultural machine while the agricultural machine is making a turn; and
the second controller is configured or programmed to perform a control to increase the distance between the agricultural machine and the transport vehicle after the first controller performs a control to stop the discharge of the harvested crop from the agricultural machine.

3. The control system according to claim 1, wherein when the agricultural machine completes the turn, the second controller is configured or programmed to perform a control to move the transport vehicle to a position where the transport vehicle can receive the harvested crop discharged from the agricultural machine.

4. The control system according to claim 1, wherein
when the harvested crop accumulated in the agricultural machine is less than a first predetermined amount, the second controller is configured or programmed to perform a control to cause the transport vehicle to wait at a predetermined position; and
when the harvested crop accumulated in the agricultural machine has become equal to or greater than the first predetermined amount, the second controller is configured or programmed to perform a control to move the transport vehicle to a position where the transport vehicle can receive the harvested crop discharged from the agricultural machine.

5. The control system according to claim 1, wherein
when the harvested crop accumulated in the transport vehicle has become equal to or greater than the second predetermined amount:
the first controller is configured or programmed to perform a control to stop the discharge of the harvested crop from the agricultural machine; and
the second controller is configured or programmed to perform a control to move the transport vehicle to a building to store the harvested crop.

6. The control system according to claim 1, further comprising a sensor to sense at least one of the agricultural machine and the transport vehicle to output sensor data; wherein
when the agricultural machine discharges the harvested crop to the transport vehicle, the second controller is configured or programmed to control, based on the sensor data, travel of the transport vehicle to maintain a positional relationship between the transport vehicle and the agricultural machine such that the transport vehicle can receive the harvested crop discharged from the agricultural machine.

7. A transport vehicle for transporting a harvested crop that is harvested in a field, the transport vehicle comprising:
a container to receive and store the harvested crop discharged from an agricultural machine that harvests the crop in the field; and
a controller configured or programmed to:
perform an operation of the transport vehicle so that the transport vehicle travels by automated driving;
perform a control to cause the transport vehicle to travel alongside the agricultural machine when the agricultural machine is traveling while harvesting the crop and discharging the harvested crop; and
perform a control to increase a distance between the agricultural machine and the transport vehicle when the agricultural machine is making a turn, compared to when the agricultural machine is traveling while harvesting the crop.

8. The transport vehicle according to claim 7, wherein
the agricultural machine stops the discharge of the harvested crop while the agricultural machine is making a turn; and
the controller is configured or programmed to perform a control to increase the distance between the agricultural machine and the transport vehicle after the agricultural machine stops the discharge of the harvested crop.

9. The transport vehicle according to claim 7, wherein when the agricultural machine completes the turn, the controller is configured or programmed to perform a control to move the transport vehicle to a position where the transport vehicle can receive the harvested crop discharged from the agricultural machine.

10. The transport vehicle according to claim 7, wherein
when the harvested crop accumulated in the agricultural machine is less than a first predetermined amount, the controller is configured or programmed to perform a control to cause the transport vehicle to wait at a predetermined position; and
when the harvested crop accumulated in the agricultural machine has become equal to or greater than the first predetermined amount, the controller is configured or programmed to perform a control to move the transport vehicle to a position where the transport vehicle can receive the harvested crop discharged from the agricultural machine.

11. The transport vehicle according to claim 7, wherein
when the harvested crop accumulated in the container has become equal to or greater than the second predetermined amount:
the controller is configured or programmed to perform a control to move the transport vehicle to a building to store the harvested crop.

12. The transport vehicle according to claim 7, further comprising a sensor to sense the agricultural machine to output sensor data; wherein
when the agricultural machine discharges the harvested crop to the transport vehicle, the controller is configured or programmed to control, based on the sensor data, travel of the transport vehicle to maintain a positional relationship between the transport vehicle and the agricultural machine such that the transport vehicle can receive the harvested crop discharged from the agricultural machine.

13. A control method for controlling a harvesting operation performed by an agricultural machine, which harvests a crop while traveling in a field by automated driving, and a transport vehicle, which receives a harvested crop discharged from the agricultural machine while traveling alongside the agricultural machine by automated driving, the control method comprising:
controlling an operation of discharging the harvested crop of the agricultural machine; and
performing a control to increase a distance between the agricultural machine and the transport vehicle while the agricultural machine makes a turn, compared to when the agricultural machine is traveling while harvesting the crop.

14. A control method for controlling a transport vehicle that travels by automated driving and transports a harvested crop that is harvested in a field, the transport vehicle including a container to receive and store the harvested crop discharged from an agricultural machine that harvests the crop in the field, the control method comprising:
performing a control to cause the transport vehicle to travel alongside the agricultural machine when the agricultural machine is traveling while harvesting the crop and discharging the harvested crop; and
performing a control to increase a distance between the agricultural machine and the transport vehicle when the agricultural machine is making a turn, compared to when the agricultural machine is traveling while harvesting the crop.
